(19) United States
(12) Patent Application Publication
(10) Pub. No.: US 2005/0233906 A1
(43) Pub. Date: Oct. 20, 2005

(54) Oil suspension concentrate

(76) Inventors: Gerhard Schnabel, Elsenfeld (DE); Detlev Haase, Frankfurt (DE); Roland Deckwer, Frankfurt (DE)

Correspondence Address: CONNOLLY BOVE LODGE & HUTZ, LLP, P O BOX 2207, WILMINGTON, DE, 19899, US

(21) Appl. No.: 10/997,627

(22) Filed: Nov. 24, 2004

(30) Foreign Application Priority Data
May 22, 2003 (DE) 102004025220.3
Nov. 28, 2003 (WO) PCT/EP03/13389

(51) Int. Cl. A01N 47/28

(52) U.S. Cl. 504/148

(57) ABSTRACT

The present invention relates to an oil suspension concentrate, comprising a) one or more herbicidally active compounds from the group of the thienylsulfonamides, and b) one or more organic solvents. The oil suspension concentrate is suitable for use in crop protection.

The present invention relates to the field of crop protection compositions. In particular, the invention relates to liquid formulations in the form of oil suspension concentrates comprising herbicidally active compounds from the group of the thienylsulfonamides.

In general, active compounds for crop protection are not employed in pure form. Depending on the area of use and the type of use, and on physical, chemical and biological parameters, the active compound is used as an active compound formulation in a mixture with customary auxiliaries and additives. Also known are combinations with further active compounds for widening the activity spectrum and/or for protecting crop plants (for example by safeners, antidotes).

In general, formulations of active compounds for crop protection should have high chemical and physical stability, should be easy to apply and easy to use and have broad biological action combined with high selectivity.

In general, herbicidally active compounds from the group of the sulfonamides have high chemical reactivity and tend to be degraded chemically, for example by hydrolysis.

One possibility of formulating chemically unstable active compounds is the preparation of solid formulations. Thus, formulations of active compounds from the group of the sulfonamides, in the form of powders, granules and tablets are known (for example in EP 764404, WO 9834482, WO 9313658). However, the processes for preparing solid formulations, for example in the form of granules and tablets, are generally complicated, in particular when auxiliaries and additives or active compounds having a low melting point are incorporated. Moreover, solid formulations are generally more difficult to apply and less user-friendly. Liquid formulations of sulfonamides are described, for example, in U.S. Pat. No. 4,599,412, U.S. Pat. No. 4,683,000, U.S. Pat. No. 4,671,817, EP 0245058, WO 01/82693, EP 0313317, EP 0514768, EP 0163598 and EP 0514769. Thienylsulfonamides are described, for example, in WO 01/05788, WO 03/026426 and WO 03/026427.

It was an object of the present invention to provide an improved formulation of crop protection agents, which formulation has a high chemical and physical stability.

This object is achieved by the specific oil suspension concentrate of the present invention.

Accordingly, the present invention relates to an oil suspension concentrate comprising
a) one or more herbicidally active compounds from the group of the thienylsulfonamides, preferably in suspended form, and
b) one or more organic solvents.

In addition, the oil suspension concentrate according to the invention may optionally also comprise, as further components:
c) one or more safeners,
d) one or more sulfosuccinates,
e) one or more agrochemically active compounds differing from a) and c),
f) one or more inorganic salts, and
g) customary auxiliaries and additives.

The term “oil suspension concentrate” (OD) is to be understood as meaning a suspension concentrate based on organic solvents. Here, one or more active compounds are suspended in the organic solvent, further active compounds may be dissolved in the organic solvents.

In the oil suspension concentrate according to the invention, the thienylsulfonamide a) is present in suspended form in the organic solvent. This means that the major portion (in % by weight) of thienylsulfonamide a) is present undissolved in finely distributed form, a minor portion of the thienylsulfonamide a) may be dissolved. Preferably, more than 50% by weight, particularly preferably more than 80% by weight, very particularly preferably more than 90% by weight, of the thienylsulfonamide a) are suspended in the organic solvent, in each case based on the total amount of thienylsulfonamide a) in the oil suspension concentrate according to the invention.

Preferred thienylsulfonamides a) are thienylsulfonylamino(thio)carbonyltriazolin(ethi)ones, in particular those of the formula (I) 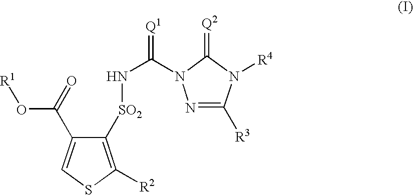
in which
Q¹ is O (oxygen) or S (sulfur), preferably O,
Q² is O (oxygen) or S (sulfur), preferably O,
R¹ is optionally cyano-, halogen- or C₁-C₄-alkoxy-substituted alkyl having 1 to 6 carbon atoms, is in each case optionally cyano- or halogen-substituted alkenyl or alkynyl having in each case 2 to 6 carbon atoms, is in each case optionally cyano-, halogen- or C₁-C₄-alkyl-substituted cycloalkyl or cycloalkylalkyl having in each case 3 to 6 carbon atoms in the cycloalkyl group and, if appropriate, 1 to 4 carbon atoms in the alkyl moiety, is in each case optionally nitro-, cyano-, halogen-, C₁-C₄-alkyl-, or C₁-C₄-alkoxy-substituted aryl or arylalkyl having in each case 6 or 10 carbon atoms in the aryl group and, if appropriate, 1 to 4 carbon atoms in the alkyl moiety, or is in each case optionally nitro-, cyano-, halogen-, C₁-C₄-alkyl- or C₁-C₄-alkoxy-substituted heterocyclyl or heterocyclylalkyl having in each case up to 6 carbon atoms and additionally 1 to 4 nitrogen atoms and/or 1 or 2 oxygen or sulfur atoms in the heterocyclyl group and, if appropriate, 1 to 4 carbon atoms in the alkyl moiety,
R² is hydrogen, cyano, nitro, halogen, is in each case optionally cyano-, halogen- or C₁-C₄-alkoxy-substituted alkyl, alkoxy, alkoxycarbonyl, alkylthio, alkylsulfynyl or alkylsulfonyl having in each case 1 to 6 carbon atoms in the alkyl group, or is in each case optionally cyano- or halogen-substituted alkenyl, alkynyl, alkenyloxy or alkynyloxy having in each case 2 to 6 carbon atoms in the alkenyl or alkynyl group,
R³ is hydrogen, hydroxyl, mercapto, amino, cyano, fluorine, chlorine, bromine, iodine, is optionally fluorine-, chlorine-, bromine-, cyano-, C₁-C₄-alkoxy-, C₁-C₄-alkylcarbonyl- or C₁-C₄-alkoxy-carbonyl-substituted alkyl having 1 to 6 carbon atoms, is in each case optionally fluorine-, chlorine- and/or bromine-substituted alkenyl or alkynyl having in each case 2 to 6 carbon atoms, is in each case optionally fluorine-, chlorine-, cyano-, C₁-C₄-alkoxy- or C₁-C₄-alkoxy-carbonyl-substituted alkoxy, alkylthio, alkylamino or alkylcarbonylamino having in each case 1 to 6 carbon atoms in the alkyl group, is alkenyloxy, alkynyloxy, alkenylthio, alkynylthio, alkenylamino or alkynylamino having in each case 3 to 6 carbon atoms in the alkenyl or alkynyl group, is dialkylamino having in each case 1 to 4 carbon atoms in the alkyl groups, is in each case optionally methyl- and/or ethyl-substituted aziridino, pyrrolidino, piperidino or morpholino, is in each case optionally fluorine-, chlorine-, bromine-, cyano- and/or C₁-C₄-alkyl-substituted cycloalkyl, cycloalkenyl, cycloalkyloxy, cycloalkylthio, cycloalkylamino, cycloalkylalkyl, cycloalkylalkoxy, cycloalkylalkylthio or cycloalkylalkylamino having in each case 3 to 6 carbon atoms in the cycloalkyl or cycloalkenyl group and, if appropriate, 1 to 4 carbon atoms in the alkyl moiety, or is in each case optionally fluorine-, chlorine-, bromine-, cyano-, nitro-, C₁-C₄-alkyl-, trifluoromethyl-, C₁-C₄-alkoxy- and/or C₁-C₄-alkoxy-carbonyl-substituted aryl, arylalkyl, aryloxy, arylalkoxy, arylthio, arylalkylthio, arylamino or arylalkylamino having in each case 6 or 10 carbon atoms in the aryl group and, if appropriate, 1 to 4 carbon atoms in the alkyl moiety,
R⁴ is hydrogen, hydroxyl, amino, cyano, is C₂-C₁₀-alkylideneamino, is optionally fluorine-, chlorine-, bromine-, cyano-, C₁-C₄-alkoxy-, C₁-C₄-alkylcarbonyl- or C₁-C₄-alkoxy-carbonyl-substituted alkyl having 1 to 6 carbon atoms, is in each optionally fluorine-, chlorine- and/or bromine-substituted alkenyl or alkynyl having in each case 2 to 6 carbon atoms, is in each case optionally fluorine-, chlorine-, bromine-, cyano-, C₁-C₄-alkoxy- or C₁-C₄-alkoxy-carbonyl-substituted alkoxy, alkylamino or alkylcarbonylamino having in each case 1 to 6 carbon atoms in the alkyl group, is alkenyloxy having 3 to 6 carbon atoms, is dialkylamino having in each case 1 to 4 carbon atoms in the alkyl groups, is in each case optionally fluorine-, chlorine-, bromine-, cyano- and/or C₁-C₄-alkyl-substituted cycloalkyl, cycloalkylamino or cycloalkylalkyl having in each case 3 to 6 carbon atoms in the alkyl group and, if appropriate, 1 to 4 carbon atoms in the alkyl moiety, or is in each case optionally fluorine-, chlorine-, bromine-, cyano-, nitro-, C₁-C₄-alkyl-, trifluoromethyl- and/or C₁-C₄-alkoxy-substituted aryl or arylalkyl having in each case 6 or 10 carbon atoms in the aryl group and, if appropriate, 1 to 4 carbon atoms in the alkyl moiety, or
R³ and R⁴ together are optionally branched alkanediyl having 3 to 6 carbon atoms,
   and salts of the compounds of the formula (I).

Particular preference is given to thienylsulfonylaminocarbonyltriazolinones, for example to the compounds of the formula (II) mentioned below which are known, for example, from WO 03/026427, 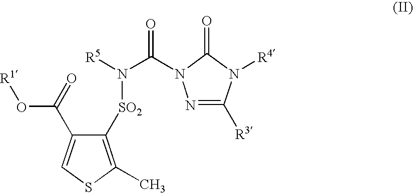
in which
R^{1′} is C₁-C₆-alkyl,
R^{3′} is C₁-C₄-alkyl, (C₁-C₄-alkoxy)-C₁-C₄-alkyl, cyclopropyl, C₁-C₄-alkoxy, C₁-C₄-alkylthio,
R^{4′} is C₁-C₄-alkyl, C₁-C₄-alkoxy, cyclopropyl,
R⁵ is H or an alkali metal ion, such as sodium or potassium.

Examples of compounds of the formula (II) are:

| Compound No. | R^{1′} | R⁵ | R^{3′} | R^{4′} |
|---|---|---|---|---|
| A1.1 | CH₃ | H | OC₂H₅ | CH₃ |
| A1.2 | CH₃ | Na | OC₂H₅ | CH₃ |
| A2.1 | CH₃ | H | OCH₃ | CH₃ |
| A2.2 | CH₃ | Na | OCH₃ | CH₃ |
| A3.1 | CH₃ | H | OC₃H₇-n | CH₃ |
| A3.2 | CH₃ | Na | OC₃H₇-n | CH₃ |
| A4.1 | CH₃ | H | OC₃H₇-i | CH₃ |
| A4.2 | CH₃ | Na | OC₃H₇-i | CH₃ |
| A5.1 | CH₃ | H | OCH₃ | cyclopropyl |
| A5.2 | CH₃ | Na | OCH₃ | cyclopropyl |
| A6.1 | CH₃ | H | OC₂H₅ | cyclopropyl |
| A6.2 | CH₃ | Na | OC₂H₅ | cyclopropyl |
| A7.1 | CH₃ | H | OC₃H₇-n | cyclopropyl |
| A7.2 | CH₃ | Na | OC₃H₇-n | cyclopropyl |
| A8.1 | CH₃ | H | OC₃H₇-i | cyclopropyl |
| A8.2 | CH₃ | Na | OC₃H₇-i | cyclopropyl |
| A9.1 | CH₃ | H | cyclopropyl | cyclopropyl |
| A9.2 | CH₃ | Na | cyclopropyl | cyclopropyl |
| A10.1 | CH₃ | H | CH₃ | CH₃ |
| A10.2 | CH₃ | Na | CH₃ | CH₃ |
| A11.1 | CH₃ | H | C₂H₅ | CH₃ |
| A11.2 | CH₃ | Na | C₂H₅ | CH₃ |
| A12.1 | CH₃ | H | SCH₃ | CH₃ |
| A12.2 | CH₃ | Na | SCH₃ | CH₃ |
| A13.1 | CH₃ | H | OCH₃ | CH₃ |
| A13.2 | CH₃ | Na | OCH₃ | CH₃ |
| A14.1 | CH₃ | H | CH₂OCH₃ | cyclopropyl |
| A14.2 | CH₃ | Na | CH₂OCH₃ | cyclopropyl |
| A15.1 | CH₃ | H | OC₂H₅ | CH₃ |
| A15.2 | CH₃ | Na | OC₂H₅ | CH₃ |
| A16.1 | CH₃ | H | OCH₃ | cyclopropyl |
| A16.2 | CH₃ | Na | OCH₃ | cyclopropyl |
| A17.1 | CH₃ | H | C₂H₅ | OC₂H₅ |
| A17.2 | CH₃ | Na | C₂H₅ | OC₂H₅ |
| A18.1 | CH₃ | H | C₂H₅ | cyclopropyl |
| A18.2 | CH₃ | Na | C₂H₅ | cyclopropyl |

For the purpose of the present invention, the thienylsulfonamides contained as component a) in the oil suspension concentrates according to the invention are in each case to be understood as meaning all use forms, such as acids, esters, salts and isomers, such as stereoisomers and optical isomers. Thus, in addition to neutral compounds, their salts for example with inorganic and/or organic counterions are in each case meant to be included. Thus, sulfonamides are capable of forming salts, for example, in which the hydrogen of the —SO₂—NH group is replaced by an agriculturally suitable cation. These salts are, for example, metal salts, in particular alkali metal salts or alkaline earth metal salts, in particular sodium and potassium salts, or else ammonium salts or salts with organic amines. Salt formation may also take place by addition of an acid to basic groups, such as, for example, amino and alkylamino. Acids suitable for this purpose are strong inorganic and organic acids, for example HCl, HBr, H₂SO₄ or HNO₃. Preferred esters are the alkyl esters, in particular the C₁-C₁₀-alkyl esters, such as methyl esters.

Whenever the term “acyl radical” is used in this description, this means the radical of an organic acid which is formally formed by removing an OH group from the organic acid, for example the radical of a carboxylic acid and radicals of acids derived therefrom, such as thiocarboxylic acid, unsubstituted or N-substituted iminocarboxylic acids or the radicals of carbonic monoesters, unsubstituted or N-substituted carbaminic acids, sulfonic acids, sulfinic acids, phosphonic acids, phosphinic acids.

An acyl radical is preferably formyl or acyl from the group consisting of CO—R^{Z}, CS—R^{Z}, CO—OR^{Z}, CS—OR^{Z}, CS—SR^{Z}, SOR^{Z} and SO₂R^{Z}, where R^{Z} is in each case a C₁-C₁₀-hydrocarbon radical, such as C₁-C₁₀-alkyl or C₆-C₁₀-aryl, which is unsubstituted or substituted, for example by one or more substituents from the group consisting of halogen, such as F, Cl, Br, I, alkoxy, haloalkoxy, hydroxyl, amino, nitro, cyano and alkylthio, or R^{Z} is aminocarbonyl or aminosulfonyl, where the two last-mentioned radicals are unsubstituted, N-monosubstituted or N,N-disubstituted, for example by substituents from the group consisting of alkyl and aryl. Acyl is, for example, formyl, haloalkylcarbonyl, alkylcarbonyl, such as (C₁-C₄)-alkyl-carbonyl, phenylcarbonyl, where the phenyl ring may be substituted, or alkyloxy-carbonyl, such as (C₁-C₄)-alkyloxycarbonyl, phenyloxycarbonyl, benzyloxycarbonyl, alkylsulfonyl, such as (C₁-C₄)-alkylsulfonyl, alkylsulfinyl, such as C₁-C₄-(alkylsulfinyl), N-alkyl-1-iminoalkyl, such as N—(C₁-C₄)-1-imino-(C₁-C₄)-alkyl, and other radicals of organic acids.

A hydrocarbon radical is a straight-chain, branched or cyclic and saturated or unsaturated aliphatic or aromatic hydrocarbon radical, for example alkyl, alkenyl, alkynyl, cycloalkyl, cycloalkenyl or aryl.

A hydrocarbon radical has preferably 1 to 40 carbon atoms, with preference 1 to 30 carbon atoms; with particular preference, a hydrocarbon radical is alkyl, alkenyl or alkynyl having up to 12 carbon atoms or cycloalkyl having 3, 4, 5, 6 or 7 ring atoms or phenyl.

Aryl is a mono-, bi- or polycyclic aromatic system, for example phenyl, naphthyl, tetrahydronaphthyl, indenyl, indanyl, pentalenyl, fluorenyl and the like, preferably phenyl.

A heterocyclic radical or ring (heterocyclyl) can be saturated, unsaturated or heteroaromatic and unsubstituted or substituted; it preferably contains one or more heteroatoms in the ring, preferably from the group consisting of N, O and S; it is preferably an aliphatic heterocyclyl radical having 3 to 7 ring atoms or a heteroaromatic radical having 5 or 6 ring atoms and contains 1, 2 or 3 heteroatoms. The heterocyclic radical can, for example, be a heteroaromatic radical or ring (heteroaryl), such as, for example, a mono-, bi- or polycyclic aromatic system in which at least one ring contains one or more heteroatoms, for example pyridyl, pyrimidinyl, pyridazinyl, pyrazinyl, triazinyl, thienyl, thiazolyl, oxazolyl, furyl, pyrrolyl, pyrazolyl and imidazolyl, or it is a partially or fully hydrogenated radical, such as oxiranyl, oxetanyl, pyrrolidyl, piperidyl, piperazinyl, triazolyl, dioxolanyl, morpholinyl, tetrahydrofuryl. Preference is given to pyrimidinyl and triazinyl. Suitable substituents for a substituted heterocyclic radical are the substituents mentioned further below, and additionally also oxo. The oxo group may also be present at the hetero ring atoms, which may exist in different oxidation states, for example in the case of N and S.

Substituted radicals, such as substituted hydrocarbon radicals, for example substituted alkyl, alkenyl, alkynyl, aryl, phenyl and benzyl, or substituted heterocyclyl or heteroaryl, are, for example, a substituted radical which is derived from an unsubstituted parent compound, where the substituents are, for example, one or more, preferably 1, 2 or 3, radicals from the group consisting of halogen, alkoxy, haloalkoxy, alkylthio, hydroxyl, amino, nitro, carboxyl, cyano, azido, alkoxycarbonyl, alkylcarbonyl, formyl, carbamoyl, mono- and dialkylaminocarbonyl, substituted amino, such as acylamino, mono- and dialkylamino, and alkylsulfinyl, haloalkylsulfinyl, alkylsulfonyl, haloalkylsulfonyl and, in the case of cyclic radicals, also alkyl and haloalkyl, and unsaturated aliphatic radicals which correspond to the saturated hydrocarbon-containing radicals mentioned, such as alkenyl, alkynyl, alkenyloxy, alkynyloxy, etc. Among the radicals with carbon atoms, preference is given to those having 1 to 4 carbon atoms, in particular 1 or 2 carbon atoms. Preference is generally given to substituents from the group consisting of halogen, for example fluorine and chlorine, (C₁-C₄)-alkyl, preferably methyl or ethyl, (C₁-C₄)-haloalkyl, preferably trifluoromethyl, (C₁-C₄)-alkoxy, preferably methoxy or ethoxy, (C₁-C₄)-haloalkoxy, nitro and cyano. Particular preference is given here to the substituents methyl, methoxy and chlorine.

Optionally substituted phenyl is preferably phenyl which is unsubstituted or mono- or polysubstituted, preferably substituted up to three times, by identical or different radicals, preferably from the group consisting of halogen, (C₁-C₄)-alkyl, (C₁-C₄)-alkoxy, (C₁-C₄)-haloalkyl, (C₁-C₄)-haloalkoxy and nitro, for example o-, m- and p-tolyl, dimethylphenyl, 2-, 3- and 4-chlorophenyl, 2-, 3- and 4-trifluoro- and -trichlorophenyl, 2,4-, 3,5-, 2,5- and 2,3-dichlorophenyl, o-, m- and p-methoxyphenyl.

Cycloalkyl is a carbocyclic saturated ring system having preferably 3-6 carbon atoms, for example cyclopropyl, cyclobutyl, cyclopentyl or cyclohexyl.

The carbon skeleton of the carbon-containing radicals, such as alkyl, alkoxy, haloalkyl, haloalkoxy, alkylamino and alkylthio and the corresponding unsaturated and/or substituted radicals may in each case be straight-chain or branched. In these radicals, preference is given to the lower carbon skeletons having, for example, 1 to 6 carbon atoms and, in the case of unsaturated groups, 2 to 6 carbon atoms, unless specified otherwise. Alkyl radicals, also in the composite meanings such as alkoxy, haloalkyl, etc., are, for example, methyl, ethyl, n- or isopropyl, n-, iso-, t- or 2-butyl, pentyls, hexyls, such as n-hexyl, isohexyl and 1,3-dimethylbutyl, heptyls, such as n-heptyl, 1-methylhexyl and 1,4-dimethylpentyl; alkenyl and alkynyl radicals have the meaning of the possible unsaturated radicals which correspond to the alkyl radicals; alkenyl is, for example, allyl, 1-methylprop-2-en-1-yl, 2-methyl-prop-2-en-1-yl, but-2-en-1-yl, but-3-en-1-yl, 1-methyl-but-3-en-1-yl and 1-methyl-but-2-en-1-yl; alkynyl is, for example, propargyl, but-2-yn-1-yl, but-3-yn-1-yl, 1-methyl-but-3-yn-1-yl.

Halogen is, for example, fluorine, chlorine, bromine or iodine. Haloalkyl, -alkenyl and -alkynyl is alkyl, alkenyl and alkynyl, respectively, which is partially or fully substituted by halogen, preferably by fluorine, chlorine and/or bromine, in particular by fluorine or chlorine, for example CF₃, CHF₂, CH₂F, CF₃CF₂, CH₂FCHCl, CCl₃, CHCl₂, CH₂CH₂Cl; haloalkoxy is, for example, OCF₃, OCHF₂, OCH₂F, CF₃CF₂O, OCH₂CF₃ and OCH₂CH₂Cl; this applies correspondingly to haloalkenyl and other halogen-substituted radicals.

The oil suspension concentrates according to the invention comprise the herbicidally active compounds a) from the group of the thienylsulfonamides in general in amounts of from 0.01 to 50% by weight, preferably from 0.1 to 30% by weight; here and in the entire description, the term “% by weight” refers to the relative weight of the component in question based on the total weight of the formulation, unless defined otherwise.

Suitable organic solvents (component b) are, for example:
1) hydrocarbons, which may be unsubstituted or substituted, for example
1a) aromatic hydrocarbons, for example
   mono- or polyalkyl-substituted benzenes, such as toluene, xylenes, mesitylene, ethylbenzene, or
   mono- or polyalkyl-substituted naphthalenes, such as 1-methylnaphthalene, 2-methylnaphthalene or dimethylnaphthalene, or
   other benzene-derived aromatic hydrocarbons, such as indane or Tetralin®, or
   mixtures thereof,
1 b) aliphatic hydrocarbons, for example
   straight-chain or branched aliphatics, for example of the formula CₙH₂ₙ₊₂, such as pentane, hexane, octane, 2-methylbutane or 2,2,4-trimethylpentane, or
   cyclic, optionally alkyl-substituted aliphatics, such as cyclohexane or methylcyclopentane, or
   mixtures thereof, such as solvents of the Exxsol® D series, Isopar® series or Bayol® series, for example Bayol® 82 (ExxonMobil Chemicals), or the Isane® IP series or Hydroseal® G series (TotalFinaElf),
1c) mixtures of aromatic and aliphatic hydrocarbons, such as solvents of the Solvesso® series, for example Solvesso® 100, Solvesso® 150 or Solvesso® 200 (ExxonMobil Chemicals), of the Solvarex®/Solvaro® series (TotalFinaElf) or the Caromax® series, for example Caromax®28 (Petrochem Carless), or
1d) halogenated hydrocarbons, such as halogenated aromatic and aliphatic hydrocarbons, such as chlorobenzene or methylene chloride, or
2) polar solvents, for example aprotic polar solvents, such as fully etherified and fully esterified C₁-C₉-alkanoic acids which may be mono-, di- or polyfunctional, for example the ethers and esters with C₁-C₁₈-alkyl alcohols, ketones with a low tendency to tautomerize, phosphoric acid esters, amides, nitriles or sulfones, for example diisobutyl adipate, Rhodiasolv® RPDE (Rhodia), cyclohexanone, Jeffsol® PC (Huntsman), γ-butyrolactone, N-methylpyrrolidone, dimethyl sulfoxide, acetonitrile, tributylphosphatam or the Hostarex® PO series (Clariant), or protic polar solvents, such as alcohols, amines, carboxylic acids. The alcohols, amines or carboxylic acids preferably have 1 to 18 carbon atoms and can be straight-chain, branched or cyclic and saturated or unsaturated and may optionally comprise heteroatoms and be mono- or polyfunctional. Examples of alcohols are polyhydric C₁-C₁₀-alcohols, such as methanol, ethanol, propanol, isopropanol, heptanol, octanol, isooctanol or phenol, or polyols, such as glycerol or polyglycols, commercially available, for example, as Exxal® series (ExxonMobil), Agrisynth® PA (ISP), Arcosolv® series (Lyondell Chemical) or Nacol® 6-98 (DEA). Examples of amines are diethylamine, hexylamine or aniline. Examples of carboxylic acids are adipic acid and adipic acid monoesters.
3) fatty acid esters, for example of natural origin, for example natural oils, such as animal oils or vegetable oils, or of synthetic origin, for example the Edenor® series, for example Edenor® MEPa or Edenor® MESU, or the Agnique® ME series or Agnique® AE series (Cognis), the Salim® ME series (Salim), the Radia® series, for example Radia® 30167 (ICI), the Prilube® series, for example Prilube® 1530 (Petrofina), the Stepan® C series (Stepan) or the Witconol®23 series (Witco). The fatty acid esters are preferably esters of C₁₀-C₂₂-, with preference C₁₂-C₂₀-, fatty acids. The C₁₀-C₂₂-fatty acid esters are, for example, esters of unsaturated or saturated C₁₀-C₂₂-fatty acids, in particular those having an even number of carbon atoms, for example erucic acid, lauric acid, palmitic acid, and in particular C₁₈-fatty acids, such as stearic acid, oleic acid, linoleic acid or linolenic acid.

Examples of fatty acid esters such as C₁₀-C₂₂-fatty acid esters are glycerol and glycol esters of fatty acids such as C₁₀-C₂₂-fatty acids, or transesterification products thereof, for example fatty acid alkyl esters such as C₁₀-C₂₂-fatty acid C₁-C₂₀-alkyl esters, which can be obtained, for example, by transesterification of the abovementioned glycerol or glycol fatty acid esters such as C₁₀-C₂₂-fatty acid esters with C₁-C₂₀-alcohols (for example methanol, ethanol, propanol or butanol). The transesterification can be carried out by known methods, as described, for example, in Römpp Chemie Lexikon, 9th edition, volume 2, page 1343, Thieme Verlag Stuttgart.

Preferred fatty acid alkyl esters such as C₁₀-C₂₂-fatty acid C₁-C₂₀-alkyl esters are methyl esters, ethyl esters, propyl esters, butyl esters, 2-ethylhexyl esters and dodecyl esters. Preferred glycol and glycerol fatty acid esters such as C₁₀-C₂₂-fatty acid esters are the uniform or mixed glycol esters and glycerol esters of C₁₀-C₂₂-fatty acids, in particular of such fatty acids having an even number of carbon atoms, for example erucic acid, lauric acid, palmitic acid and in particular C₁₈-fatty acids such as stearic acid, oleic acid, linoleic acid or linolenic acid.

Animal oils b) are generally known and commercially available. For the purpose of the present invention, the term “animal oils” is to be understood as meaning, for example, oils of animal origin such as whale oil, cod-liver oil, musk oil or mink oil.

Vegetable oils b) are generally known and commercially available. For the purpose of the present invention, the term “vegetable oils” is to be understood as meaning, for example, oils of oleaginous plant species, such as soybean oil, rapeseed oil, corn oil, sunflower oil, cottonseed oil, linseed oil, coconut oil, palm oil, thistle oil, walnut oil, arachis oil, olive oil or castor oil, in particular rapeseed oil, where the vegetable oils also include their transesterification products, for example alkyl esters, such as rapeseed oil methyl ester or rapeseed oil ethyl ester.

The vegetable oils are preferably esters of C₁₀-C₂₂-, preferably C₁₂-C₂₀-, fatty acids. The C₁₀-C₂₂-fatty acid esters are, for example, esters of unsaturated or saturated C₁₀-C₂₂-fatty acids having, in particular, an even number of carbon atoms, for example erucic acid, lauric acid, palmitic acid and in particular C₁₈-fatty acids such as stearic acid, oleic acid, linoleic acid or linolenic acid.

Examples of vegetable oils are C₁₀-C₂₂-fatty acid esters of glycerol or glycol with C₁₀-C₂₂-fatty acids, or C₁₀-C₂₂-fatty acid C₁-C₂₀-alkyl esters which can be obtained, for example, by transesterification of the glycerol or glycol C₁₀-C₂₂-fatty acid esters mentioned above with C₁-C₂₀-alcohols (for example methanol, ethanol, propanol or butanol). The transesterification can be carried out by known methods as described, for example, in Römpp Chemie Lexikon, 9th edition, volume 2, page 1343, Thieme Verlag Stuttgart.

The vegetable oils can be contained in the oil suspension concentrates according to the invention for example in the form of commercially available vegetable oils, in particular rapeseed oils, such as rapeseed oil methyl ester, for example Phytorob® B (Novance, France), Edenor® MESU and the Agnique® ME series (Cognis, Germany) the Radia® series (ICI), the Prilube® series (Petrofina), or biodiesel or in the form of commercially available plant-oil-containing formulation additives, in particular those based on rapeseed oils, such as rapeseed oil methyl esters, for example Hasten® (Victorian Chemical Company, Australia, hereinbelow referred to as Hasten, main ingredient: rapeseed oil ethyl ester), Actirob® B (Novance, France, hereinbelow referred to as Actirob B, main ingredient: rapeseed oil methyl ester), Rako-Binol® (Bayer AG, Germany, hereinbelow referred to as Rako-Binol, main ingredient: rapeseed oil), Renol® (Stefes, Germany, hereinbelow referred to as Renol, vegetable oil ingredient: rapeseed oil methyl ester) or Stefes Mero® (Stefes, Germany, hereinbelow referred to as Mero, main ingredient: rapeseed oil methyl ester).

Examples of synthetic fatty acid esters are, for example, those derived from fatty acids having an odd number of carbon atoms, such as C₁₁-C₂₁-fatty acid esters.

Preferred organic solvents b) are aromatic hydrocarbons and/or aliphatic hydrocarbons and fatty acid esters, such as vegetable oils, such as triglycerides of fatty acids having 10 to 22 carbon atoms, which may be saturated or else unsaturated, straight-chain or branched and which may or may not carry further functional groups, such as corn oil, rapeseed oil, sunflower oil, cottonseed oil, linseed oil, soybean oil, coconut oil, palm oil, thistle oil or castor oil, and their transesterification products, such as fatty acid alkyl esters, and mixtures thereof.

The solvents may be present on their own or as a mixture. The solubilizing power of the solvent or solvent mixture used for the thienylsulfonamide(s) used (component a) is preferably low.

The total proportion of solvents in the oil suspension concentrates according to the invention is generally between 5 and 95% by weight, preferably in the range between 20 and 80% by weight. The proportion of polar solvents such as aprotic polar solvents is generally below 20% by weight, preferably in the range from 0 to 10% by weight.

The oil suspension concentrates according to the invention comprise, as optional component c), safeners which are suitable for reducing or preventing damage to the crop plant. Suitable safeners are known, for example, from WO-A-96/14747 and the literature cited therein. In the organic solvent, the safeners can be present in suspended and/or dissolved form, preferably in dissolved form.

Suitable safeners are, for example, the following groups of compounds:
1) Compounds of the type of dichlorophenylpyrazoline-3-carboxylic acid (S1), preferably compounds such as ethyl 1-(2,4-dichlorophenyl)-5-(ethoxy-carbonyl)-5-methyl-2-pyrazoline-3-carboxylate (S1-1, mefenpyr-diethyl, PM pp. 781-782), and related compounds, as described in WO 91/07874.
2) Derivatives of dichlorophenylpyrazolecarboxylic acid, preferably compounds such as ethyl 1-(2,4-dichlorophenyl)-5-methylpyrazole-3-carboxylate (S1-2), ethyl 1-(2,4-dichlorophenyl)-5-isopropylpyrazole-3-carboxylate (S1-3), ethyl 1-(2,4-dichlorophenyl)-5-(1,1-dimethylethyl)pyrazole-3-carboxylate (S1-4), ethyl 1-(2,4-dichlorophenyl)-5-phenylpyrazole-3-carboxylate (S1-5) and related compounds, as described in EP-A-333 131 and EP-A-269 806.
3) Compounds of the type of the triazolecarboxylic acids (S1), preferably compounds such as fenchlorazole, i.e. ethyl 1-(2,4-dichlorophenyl)-5-trichloro-methyl-(1H)-1,2,4-triazole-3-carboxylate (S1-6, fenchlorazole-ethyl, PM pp. 385-386), and related compounds (see EP-A-174 562 and EP-A-346 620).
4) Compounds of the type of the 5-benzyl- or 5-phenyl-2-isoxazoline-3-carboxylic acid, or the 5,5-diphenyl-2-isoxazoline-3-carboxylic acid, preferably compounds such as ethyl 5-(2,4-dichlorobenzyl)-2-isoxazoline-3-carboxylate (S1-7) or ethyl 5-phenyl-2-isoxazoline-3-carboxylate (S1-8) and related compounds, as described in WO 91/08202, or ethyl 5,5-diphenyl-2-isoxazolinecarboxylate (S1-9, isoxadifen-ethyl) or n-propyl ester (S1-10) or ethyl 5-(4-fluorophenyl)-5-phenyl-2-isoxazoline-3-carboxylate (S1-11), as described in the patent application (WO-A-95/07897).
5) Compounds of the type of the 8-quinolineoxyacetic acid (S2), preferably 1-methylhex-1-yl(5-chloro-8-quinolineoxy)acetate (S2-1, cloquintocet-mexyl, PM pp. 263-264), 1,3-dimethylbut-1-yl(5-chloro-8-quinolineoxy)acetate (S2-2), 4-allyloxybutyl(5-chloro-8-quinolineoxy)acetate (S2-3), 1-allyloxyprop-2-yl(5-chloro-8-quinolineoxy)acetate (S2-4), ethyl(5-chloro-8-quinolineoxy)acetate (S2-5), methyl(5-chloro-8-quinolineoxy)acetate (S2-6), allyl(5-chloro-8-quinolineoxy)acetate (S2-7), 2-(2-propylideneiminooxy)-1-ethyl(5-chloro-8-quinolineoxy)acetate (S2-8), 2-oxoprop-1-yl(5-chloro-8-quinolineoxy)acetate (S2-9) and related compounds, as described in EP-A-86 750, EP-A-94 349 and EP-A-191 736 or EP-A-0 492 366.
6) Compounds of the type of the (5-chloro-8-quinolineoxy)malonic acid, preferably compounds such as diethyl(5-chloro-8-quinolineoxy)malonate, diallyl(5-chloro-8-quinolineoxy)malonate, methyl ethyl(5-chloro-8-quinoline-oxy)malonate and related compounds, as described in EP-A-0 582 198.
7) Active compounds of the type of the phenoxyacetic or -propionic acid derivatives or the aromatic carboxylic acids, such as, for example, 2,4-dichlorophenoxyacetic acid (esters) (2,4-D), 4-chloro-2-methylphenoxy-propionic esters (mecoprop), MCPA or 3,6-dichloro-2-methoxybenzoic acid (esters) (dicamba).
8) Active compounds of the type of the pyrimidines, such as “fenclorim” (PM, pp. 512-511) (=4,6-dichloro-2-phenylpyrimidine).
9) Active compounds of the type of the dichloroacetamides, which are frequently used as pre-emergence safeners (soil-acting safeners), such as, for example,
   “dichlormid” (PM, pp. 363-364) (═N,N-diallyl-2,2-dichloroacetamide),
   “R-29148” (=3-dichloroacetyl-2,2,5-trimethyl-1,3-oxazolidone from Stauffer),
   “benoxacor” (PM, pp. 102-103) (=4-dichloroacetyl-3,4-dihydro-3-methyl-2H-1,4-benzoxazine),
   “PPG-1292” (═N-allyl-N-[(1,3-dioxolan-2-yl)methyl]dichloroacetamide from PPG Industries),
   “DK-24” (═N-allyl-N-[(allylaminocarbonyl)methyl]dichloroacetamide from Sagro-Chem),
   “AD-67” or “MON 4660” (=3-dichloroacetyl-1-oxa-3-azaspiro[4,5]decane from Nitrokemia or Monsanto),
   “dicyclonon” or “BAS145138” or “LAB145138” (=3-dichloroacetyl-2,5,5-tri-methyl-1,3-diazabiclyco[4.3.0]nonane from BASF) and
   “furilazol” or “MON 13900” (see PM, 637-638) (=(RS)-3-dichloroacetyl-5-(2-furyl)-2,2-dimethyloxazolidone).
10) Active compounds of the type of the dichloroacetone derivatives, such as, for example,
   “MG 191” (CAS-Reg. No. 96420-72-3) (=2-dichloromethyl-2-methyl-1,3-dioxolane from Nitrokemia).
11) Active compounds of the type of the oxyimino compounds, which are known as seed dressings, such as, for example,
   “oxabetrinil” (PM, pp. 902-903) (=(Z)-1,3-dioxolan-2-ylmethoxyimino-(phenyl)acetonitrile), which is known as seed dressing safener against metolachlor damage,
   “fluxofenim” (PM, pp. 613-614) (=1-(4-chlorophenyl)-2,2,2-trifluoro-1-ethanone O-(1,3-dioxolan-2-ylmethyl) oxime which is known as seed dressing safener against metolachlor damage, and
   “cyometrinil” or “CGA-43089” (PM, p. 1304) (=(Z)-cyanomethoxyimino-(phenyl)acetonitrile), which is known as seed dressing safener against metolachlor damage.
12) Active compounds of the type of the thiazolecarboxylic esters, which are known as seed dressings, such as, for example,
   “flurazole” (PM, pp. 590-591) (=benzyl 2-chloro-4-trifluoromethyl-1,3-thiazole-5-carboxylate), which is known as seed dressing safener against alachlor and metolachlor damage.
13) Active compounds of the type of the naphthalenedicarboxylic acid derivatives, which are known as seed dressings, such as, for example,
   “naphthalic anhydride” (PM, p. 1342) (=1,8-naphthalenedicarboxylic anhydride), which is known as seed dressing safener for corn against thiocarbamate herbicide damage.
14) Active compounds of the type of the chromanacetic acid derivatives, such as, for example,
   “CL 304415” (CAS-Reg. No. 31541-57-8) (=2-84-carboxychroman-4-yl)acetic acid from American Cyanamid).
15) Active compounds which, in addition to a herbicidal action against harmful plants, also have safener action on crop plants such as, for example,
   “dimepiperate” or “MY-93” (PM, pp. 404-405) (═S-1-methyl-1-phenylethyl piperidine-1-thiocarboxylate),
   “daimuron” or “SK 23” (PM, p. 330) (=1-(1-methyl-1-phenylethyl)-3-p-tolyl-urea),
   “cumyluron”=“JC-940” (=3-(2-chlorophenylmethyl)-1-(1-methyl-1-phenyl-ethyl)urea, see JP-A-60087254),
   “methoxyphenone” or “NK 049” (=3,3′-dimethyl-4-methoxybenzophenone),
   “CSB” (=1-bromo-4-(chloromethylsulfonyl)benzene) (CAS-Reg No. 54091-06-4 from Kumiai).

Compounds of the type of the acylsulfamoylbenzamides, for example of formula (VIII) below, which are known, for example, from WO 99/16744.

| | |
|---|---|
| | (VIII) |
| 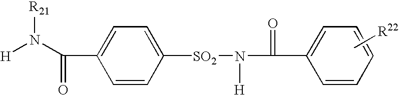 | |

| Compound No. | R²¹ | R²² |
|---|---|---|
| S3-1 | cyclopropyl | 2-OCH₃ |
| S3-2 | cyclopropyl | 2-OCH₃, 5-Cl |
| S3-3 | ethyl | 2-OCH₃ |
| S3-4 | isopropyl | 2-OCH₃, 5-Cl |
| S3-5 | isopropyl | 2-OCH₃ |

Preferred safeners are mefenpyr, fenchlorazole, isoxadifen, cloquintocet, and their C₁-C₁₀-alkyl esters, and also the safeners (S3-1) and benoxacor (S-4), in particular mefenpyr-diethyl (S1-1), fenchlorazole-ethyl (S1-6), isoxadifen-ethyl (S1-9), cloquintocet-mexyl (S2-1), (S3-1) and benoxacor (S-4).

If the oil suspension concentrates according to the invention comprise safeners c), their proportion by weight is generally from 0.1 to 60% by weight, in particular from 1 to 40% by weight, particularly preferably from 2 to 40% by weight, very particularly preferably from 2 to 30% by weight.

The weight ratio of component a) to component c) can vary within a wide range and is generally between 1:100 and 100:1, preferably between 1:10 and 10:1.

Suitable optional agrochemically active compounds e) are, for example, agrochemically active compounds different from components a) and c), such as herbicides, fungicides, insecticides, plant growth regulators and the like. The agrochemically active compounds e) can be present in the organic solvent in suspended and/or dissolved form.

Suitable agrochemically active compounds (e) (which are different from components (a) and (c) and may or may not be present) for the oil suspension concentrates according to the invention are in particular herbicides, for example the known herbicides mentioned below, as described, for example, in Weed Research 26, 441-445 (1986), or in “The Pesticide Manual”, 13th edition, The British Crop Protection Council, 2003, and the literature cited therein, for example in formulated mixtures or as components for tank mixes. The compounds are referred to either by the “common name” according to the International Organization for Standardization (ISO) or by the chemical name, if appropriate together with a customary code number, and including in each case all use forms, such as acids, salts, esters and isomers, such as stereoisomers and optical isomers: acetochlor, aclonifen, alachlor, amicarbazone, amidosulfuron, amitrole, anilofos, asulam and asulam-sodium, atrazine, benazolin and benazolin-ethyl, benfluralin, benfuresate, bispyribac-sodium, bromoxynil, bromoxynyl-heptanoate, bromoxynil-octanoate, bromoxynil-potassium, carfentrazone-ethyl, chlorsulfuron, clodinafop-propargyl, 2,4-D and its salts, amines and esters, desmedipham, dicamba and its salts, dicamba-diolamine, dichlorprop-P, diclofop-methyl, difenzoquat, difenzoquat metilsulfate, diflufenican, dimethenamid, dimethenamid-P, ethofumesate, ethoxysulfuron and its sodium salt, fenoxaprop-P-ethyl, fentrazamide, florasulam, fluazofop-P-ethyl, fluazifop-P-butyl, flucarbazone-sodium, fluazolate, flufenacet, flupyrsulfuron-methyl and its sodium salt, fluroxypyr and its esters, such as fluroxypyr-meptyl, flurtamone, foramsulfuron, glufosinate, glufosinate-ammonium, glyphosate, glyphosate-ammonium, glyphosate-isopropyl-ammonium, glyphosate-sodium, glyphosate-trimesium, imazamox, imazapic, iodosulfuron-methyl-sodium, ioxynil, ioxynil-octanoate, ioxynil-sodium, isoproturon, isoxachlortole ([4-chloro-2-(methylsulfonyl)phenyl](5-cyclopropyl-4-isoxazolyl) methanone known from EP 470 856), isoxaflutole, lactofen, linuron, MCPA, mecoprop-P, mefenacet, mesosulfuron-methyl and its sodium salt, mesotrione, metamitron, methabenzthiazuron, metobromuron, metolachlor, S-metolachlor, metosulam, metribuzin, metsulfuron, metsulfuron-methyl, neburon, nicosulfuron, oxadiargyl, oxadiazon, oxaziclomefone, pendimethalin, phenmedipham, picolinafen, propoxycarbazone-sodium, prosulfuron, pyraclonil (1-(3-chloro-4,5,6,7-tetrahydropyrazolo[1,5-a]pyridin-2-yl)-5-(methyl-2-propinylamino)-1H-pyrazole-4-carbonitrile known from WO 94/08999), pyraflufen-ethyl, rimsulfuron, sulcotrione, sulfosate, sulfosulfuron, terbuthylazine, thifensulfuron-methyl, tralkoxydim, triasulfuron, tribenuron-methyl, tritosulfuron (N-[[[4-methoxy-6-(trifluoromethyl)-1,3,5-triazin-2-yl]amino]carbonyl]-2-(trifluoromethyl)-benzenesulfonamide (B. 264) known from DE 4038430), 4-(4,5-dihydro-4-methyl-5-oxo-3-trifluoromethyl-1H-1,2,4-triazol-1-yl)-2-(ethylsulfonylamino)-5-fluorobenzenecarbothioamide (HWH4991, cf. WO-A-95/30661), 2-chloro-N-[1-(2,6-dichloro-4-difluoromethyl-phenyl)-4-nitro-1H-pyrazol-5-yl]propanecarboxamide (SLA5599, cf. EP-A-303153), and the compounds

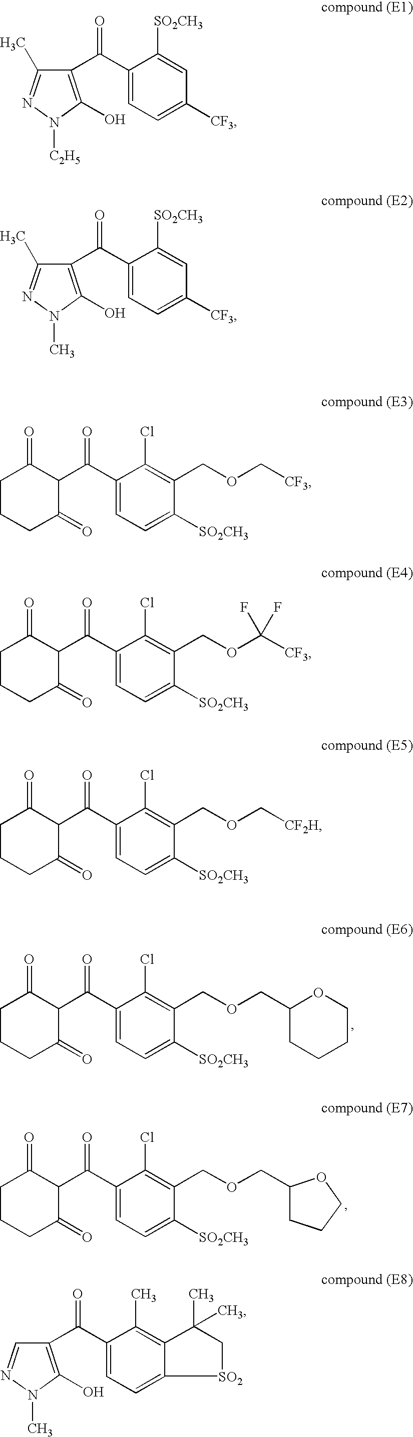

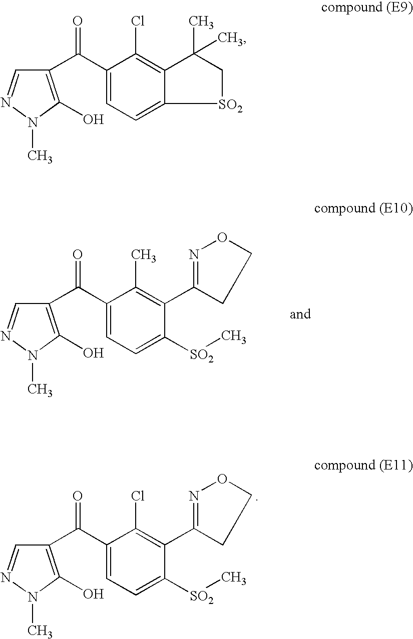

The compounds (E1) and (E2) are known from WO 01/74785, the active compounds (E3) to (E7) are known from WO 00/21924 and the other active compounds (E8) to (E11) are known from WO 96/26206, WO 96/25412 and U.S. 20020016262.

Preferred components e) are (E1), (E2), (E3), (E4), (E5), (E6), (E7), (E8), (E9), (E10) and (E11) in all their use forms, including the salts, in particular the alkali metal salts, such as sodium or potassium salts, and also bromoxynil (E12), mesosulfuron (E13), diflufenican (E14), sulcotrione (E15), mesotrione (E16), rimsulfuron (E17), foramsulfuron (E18), nicosulfuron (E19), flufenacet (E20), isoxaflutole (E21), iodosulfuron (E22), flupyrsulfuron (E23), glyphosate (E24), atrazine (E25), fenoxaprop (E26), propoxycarbazone (E27), amidosulfuron (E28) and ethoxysulfuron (E29), in all their use forms including the salts and esters, in particular the alkali metal salts, such as sodium or potassium salts, and the C₁-C₁₀-alkyl esters, such as methyl, ethyl, butyl, heptyl or octyl esters.

If the oil suspension concentrates according to the invention contain agrochemically active compounds e), their proportion by weight is generally from 0.5 to 50% by weight, in particular from 3 to 20% by weight.

The total amount of active compound (sum of components a)+c)+e)) contained in the oil suspension concentrates according to the invention is generally from 1 to 80% by weight, in particular from 2 to 60% by weight.

The sulfosuccinates (component d) optionally contained in the oil suspension concentrates according to the invention can, for example, be mono- or diesters of sulfosuccinic acid, preferably those of the formula (III)
R¹—(X₁)ₙ—O—CO—CH₂—CH(SO₃M)-CO—O—(X₂)ₘ—R² (III)
in which
R¹ is H or an unsubstituted or substituted C₁-C₃₀-hydrocarbon radical, such as C₁-C₃₀-alkyl or C₇-C₃₀-alkylaryl,
R² is H or an unsubstituted or substituted C₁-C₃₀-hydrocarbon radical, such as C₁-C₃₀-alkyl or C₇-C₃₀-alkylaryl, or a cation, for example a metal cation, such as an alkali metal or alkaline earth metal cation, or an ammonium cation, such as NH₄ or an alkyl-, alkylaryl- or poly(arylalkyl)-phenylammonium cation,
X¹, X² are identical or different and independently of one another are a spacer unit, such as a polyether unit or a polyester unit,
n, m are identical or different and independently of one another are zero or 1, preferably zero, and
M is a cation, for example a metal cation, such as an alkali metal or alkaline earth metal cation, or an ammonium cation, such as NH₄ or an alkyl-, alkylaryl- or poly(arylalkyl)phenylammonium cation.

Preference is given to sulfosuccinates of the formula (III) in which R¹ and R² are identical or different and independently of one another are linear, branched or cyclic, saturated or unsaturated C₁-C₂₀-, preferably C₄-C₁₈-, alkyl radicals, such as methyl, ethyl, butyl, hexyl, cyclohexyl, octyl, such as 2-ethylhexyl, decyl, tridecyl or octadecyl radicals, or R¹ and R² are C₇-C₂₀-alkylaryl radicals, such as nonylphenyl, 2,4,6-tri-sec-butylphenyl, 2,4,6-tris-(1-phenylethyl)phenyl, alkylbenzyl or a hydrocinnamic radical,
X₁ and X₂ are identical or different and independently of one another are polyether units, such as polyethylene glycols —(C₂H₄O)ₚ— or polypropylene glycols —(C₃H₆O)_{q}— where p=1 to p=20, in particular p=1 to p=12, or polyester units, such as polyhydroxybutyric acid —(CH[CH₃]—CH₂—COO)_{q}— or polylactic acid —(CH[CH₃]—COO)_{q}— where q=1 to q=15, in particular q=1 to q=8,
n, m are identical or different and independently of one another are zero or 1, preferably zero, and M is a cation, for example a metal cation, such as an alkali metal or alkaline earth metal cation, or an ammonium cation which may be alkyl-substituted.

Examples of sulfosuccinates contained according to the invention are
a1) sulfosuccinate which is esterified once or twice with linear, cyclic or branched aliphatic, cycloaliphatic and/or aromatic alcohols, having, for example, 1 to 22 carbon atoms in the alkyl radical, preferably mono- or dialkali metal sulfosuccinate, in particular mono- or disodium sulfosuccinate, which is esterified once or twice with methanol, ethanol, (iso)propanol, (iso)butanol, (iso)pentanol, (iso)hexanol, cyclohexanol, (iso)heptanol, (iso)octanol (in particular: ethylhexanol), (iso)nonanol, (iso)decanol, (iso)undecanol, (iso)dodecanol or (iso)tridecanol,
a2) sulfosuccinate which is esterified once or twice with (poly)alkylene oxide adducts of alcohols, having, for example, 1 to 22 carbon atoms in the alkyl radical and 1 to 200, preferably 2 to 200, alkylene oxide units in the (poly)alkylene oxide moiety, preferably mono- or dialkali metal sulfosuccinate, in particular mono- or disodium sulfosuccinate, which is esterified once or twice with dodecyl/tetradecyl alcohol +2-5 mol of ethylene oxide or with i-tridecyl+3 mol of ethylene oxide,
a3) the dialkali metal salt, preferably the disodium salt, of maleic anhydride which has been reacted with one equivalent of an amine or an amino-terminated (poly)alkylene oxide adduct of an alcohol, an amine, a fatty acid, an ester or an amide and then sulfonated, having, for example, 1 to 22 carbon atoms in the alkyl radical and 1 to 200, preferably 2 to 200, oxyalkylene units in the (poly)alkylene oxide moiety, preferably the disodium salt of maleic anhydride which has been reacted with one equivalent of coconut fatty amine and then sulfonated,
a4) the dialkali metal salt, preferably the disodium salt, of maleic anhydride which has been reacted with one equivalent of an amide or a (poly)alkylene oxide adduct of an amide and then sulfonated, having, for example, 1 to 22 carbon atoms in the alkyl radical and 1 to 200, preferably 2 to 200, oxyalykylene units in the (poly)alkylene oxide moiety, preferably the disodium salt of maleic anhydride which has been reacted with one equivalent of oleylamide+2 mol of ethylene oxide and then sulfonated, and/or
a5) the tetraalkali metal salt, preferably the tetrasodium salt, of N-(1,2-dicarboxy-ethyl)-N-octadecylsulfosuccinamate.

Examples of sulfosuccinates of groups a1) to a5) which are commercially available and preferred within the context of the present invention are listed below:
a1) sodium dialkylsulfosuccinate, for example sodium di-(C₄-C₁₈)-alkylsulfosuccinate, such as sodium diisooctylsulfosuccinate, preferably sodium di-(2-ethylhexyl)sulfosuccinate, commercially available, for example, in the form of the Aerosol® brands (Cytec), the Agrilan® or Lankropol® brands (Akzo Nobel), the Empimin® brands (Albright&Wilson), the Cropol® brands (Croda), the Lutensit® brands (BASF), the Triton brands (Union Carbide), the Geropon® brands (Rhodia) or the Imbirol®, Madeol® or Polirol® brands (Cesalpinia),
a2) sodium alcohol polyethylene glycol ether sulfosuccinate, commercially available, for example, in the form of Geropon® ACR brands (Rhodia),
a3) disodium alcohol polyethylene glycol ether semisulfosuccinate, commercially available, for example, in the form of the Aerosol® brands (Cytec), the Marlinat® or Sermul® brands (Condea), the Empicol® brands (Albright&Wilson), the Secosole brands (Stepan), the Geropon® brands (Rhodia), the Disponil® or Texapon® brands (Cognis) or the Rolpon® brands (Cesalpinia),
a4) disodium N-alkylsulfosuccinamate, commercially available, for example, in the form of the Aerosol® brands (Cytec), the Rewopol® or Rewoderm® brands (Rewo), the Empimin® brands (Albright&Wilson), the Geropon® brands (Rhodia) or the Polirol® brands (Cesalpinia),
a5) disodium fatty acid amide polyethylene glycol ether semisulfosuccinate, commercially available, for example, in the form of the Elfanol® or Lankropol® brands (Akzo Nobel), the Rewoderm®, Rewocid® or Rewopol® brands (Rewo), the Emcol® brands (Witco), the Standapol® brands (Cognis) or the Rolpon® brands (Cesalpinia), and
a6) tetrasodium N-(1,2-dicarboxyethyl)-N-octadecylsulfosuccinamate, commercially available, for example, in the form of Aerosol 22® (Cytec).

Sulfosuccinates are commercially available, for example, as Aerosol® (Cytec), Agrilan® or Lankropol® (Akzo Nobel), Empimin® (Huntsman), Cropol® (Croda), Lutensit® (BASF), Triton® GR series (UnionCarbide), Imbirol®/Madeol®/Polirol® (Cesalpinia); as Geropon®AR series or as Geropon® SDS (Rhodia).

Preferred sulfosuccinates are, for example, the sodium, potassium and ammonium salts of bis(alkyl)sulfosuccinates, where the alkyl radicals are identical or different and contain 4 to 16 carbon atoms and are preferably butyl, hexyl, octyl, such as 2-ethylhexyl or decyl radicals, which may be straight-chain or branched.

If the oil suspension concentrates according to the invention contain sulfosuccinates d), their proportion by weight is generally from 0.5 to 60% by weight, in particular from 1 to 30% by weight.

The inorganic salts f) optionally contained in the oil suspension concentrates according to the invention are preferably basic inorganic salts. These are to be understood as meaning salts which, in 1% strength aqueous solution, have a pH >7, preferably weakly basic salts having a pH between 7 and 11. Examples of such salts are carbonates, bicarbonates, hydroxides, oxides, hypochlorites and sulfites, preferably carbonates and bicarbonates. As cations, the inorganic salts preferably contain metal ions, in particular alkali metal, alkaline earth metal and transition metal ions, preferably alkali metal and alkaline earth metal ions, such as sodium, potassium, magnesium or calcium. Particularly preferred salts are alkali metal salts, in particular alkali metal carbonates and alkali metal bicarbonates, such as Na₂CO₃, K₂CO₃, NaHCO₃ and KHCO₃. The inorganic salts may be present on their own or in a mixture.

If the oil suspension concentrates according to the invention contain inorganic salts f), their proportion by weight is generally from 0.01 to 20% by weight, preferably from 0.01 to 10% by weight, particularly preferably from 0.05 to 5% by weight.

Customary auxiliaries and additives (component g) which may also be contained in the oil suspension concentrates according to the invention are, for example: surfactants, such as emulsifiers and dispersants, thickeners and thixotropic agents, wetting agents, anti-drift agents, adhesives, penetrants, preservatives and antifreeze agents, antioxidants, solubilizers, fillers, carriers and colorants, antifoams, fertilizers, evaporation inhibitors and agents which modify pH and viscosity.

Suitable emulsifiers and dispersants are, for example, nonionic emulsifiers and dispersants, for example:
1) polyalkoxylated, preferably polyethoxylated, saturated and unsaturated aliphatic alcohols,
   having 8 to 24 carbon atoms in the alkyl radical, which is derived from the corresponding fatty acids or from petrochemical products, and
   having 1 to 100, preferably 2 to 50, ethylene oxide units (EO), it being possible for the free hydroxyl group to be alkoxylated,
   which are commercially available, for example as Genapol® X and Genapol® O series (Clariant), Crovol® M series (Croda) or as Lutensol® series (BASF), for example Lutensol®-A series, -AT series, -AO series, —ON series, TO series or —XL series,
2) polyalkoxylated, preferably polyethoxylated, arylalkylphenols, such as, for example, 2,4,6-tris-(1-phenylethyl)phenol (tristyrylphenol) having an average degree of ethoxylation of between 10 and 80, preferably from 16 to 40, such as, for example Soprophor® BSU (Rhodia) or HOE S 3474 (Clariant),
3) polyalkoxylated, preferably polyethoxylated, alkylphenols having one or more alkyl radicals, such as, for example, nonylphenol or tri-sec-butylphenol, and a degree of ethoxylation of between 2 and 40, preferably from 4 to 15, such as, for example, Arkopal® N series or Sapogenat® T series (Clariant),
4) polyalkoxylated, preferably polyethoxylated, hydroxyfatty acids or glycerides which contain hydroxyfatty acids, such as, for example, ricinine or castor oil, having a degree of ethoxylation of between 10 and 80, preferably from 25 to 40, such as, for example, the Emulsogen® EL series (Clariant) or the Agnique® CSO series (Cognis),
5) polyalkoxylated, preferably polyethoxylated, sorbitan esters, such as, for example, Atplus® 309 F (Uniqema) or the Alkamuls® series (Rhodia),
6) polyalkoxylated, preferably polyethoxylated amine, such as, for example, Genamin® series (Clariant), for example Genamin®-C series, O series, -S series or -T series, Imbentin® CAM series (Kolb) or Lutensol® F series (BASF),
7) di- and tri-block copolymers, for example from alkylene oxides, for example from ethylene oxide and propylene oxide, having average molar masses between 200 and 10 000, preferably from 1000 to 4000, g/mol, the proportion by mass of the polyethoxylated block varying between 10 and 80%, such as, for example, the Genapol® PF series (Clariant), the Pluronic® series (BASF), or the Synperonic® PE series (Uniqema).

Preferred nonionic emulsifiers and dispersants are, for example, polyethoxylated alcohols, polyethoxylated amines, polyethoxylated triglycerides which contain hydroxyfatty acids and polyethylene oxide/polypropylene oxide block copolymers.

If the oil suspension concentrates according to the invention contain nonionic emulsifiers and dispersants, their proportion by weight is generally from 1 to 20% by weight.

Also suitable are ionic emulsifiers and dispersants, for example:
1) polyalkoxylated, preferably polyethoxylated, emulsifiers/dispersants (cf. component e) which are ionically modified, for example by conversion of the terminal free hydroxyl function of the polyethylene oxide block into a sulfate or phosphate ester (for example as alkali metal and alkaline earth metal salts), such as, for example, Genapol® LRO or dispersant 3618 (Clariant), Emulphor® (BASF) or Crafol® AP (Cognis),
2) alkali metal and alkaline earth metal salts of alkylarylsulfonic acids having a straight-chain or branched alkyl chain, such as phenylsulfonate CA or phenylsulfonate CAL (Clariant), Atlox® 3377BM (ICI), or the Empiphos® TM series (Huntsman),
3) polyelectrolytes, such as lignosulfonates, condensates of naphthalenesulfonate and formaldehyde, polystyrenesulfonate or sulfonated unsaturated or aromatic polymers (polystyrenes, polybutadienes or polyterpenes), such as the Tamol® series (BASF), Morwet® D425 (Witco), the Kraftsperse® series (Westvaco) or the Borresperse® series (Borregard).

Preferred ionic emulsifiers/dispersants are, for example, salts of alkylarylsulfonic acids and polyelectrolytes from the polycondensation of naphthalenesulfonate and formaldehyde.

If the oil suspension concentrates according to the invention contain ionic emulsifiers and dispersants, their proportion by weight is generally from 0.1 to 20% by weight, in particular from 0.5 to 8% by weight.

If nonionic or ionic emulsifiers and dispersants are used not only because of their emulsifying/dispersing properties but also to increase the biological effectiveness, for example as penetrants or tackifiers, their proportion in the oil suspension concentrates according to the invention may be increased to up to 60% by weight.

Suitable thickeners and thixotropic agents are, for example:
1) modified natural silicates, such as chemically modified bentonites, hectorites, aftapulgites, montmorillonites, smectites or other silicate minerals, such as Bentone® (Elementis), Attagel® (Engelhard), Agsorb® (Oil-Dri Corporation) or Hectorite® (Akzo Nobel),
2) synthetic silicates, such as silicates of the Sipernat®, Aerosil® or Durosil® series (Degussa), the CAB-O-SIL® series (Cabot) or the Van Gel series (R. T. Vanderbilt),
3) thickeners based on synthetic polymers, such as thickeners of the Thixin® or Thixatrol® series (Elementis),
4) thickeners based on natural polymers and natural oils, for example from the Thixin® or Thixatrol® series (Elementis).

Preferred thickeners and thixotropic agents are, for example, modified phyllosilicates and thickeners based on synthetic polymers.

If the oil suspension concentrates according to the invention contain thickeners and thixotropic agents, their proportion by weight is generally from 0.1 to 5% by weight, in particular from 0.2 to 3% by weight.

Preference is given to oil suspension concentrates according to the invention comprising:
a) from 0.1 to 30% by weight of one or more herbicidally active compounds from the group of the thienylsulfonamides,
b) from 20 to 80% by weight of one or more solvents,
c) from 0 to 40% by weight of one or more safeners,
d) from 0 to 30% by weight of one or more sulfosuccinates,
e) from 0 to 20% by weight of one or more agrochemically active compounds different from a) and c),
f) from 0 to 20% by weight of one or more inorganic salts,
g) from 0 to 20% by weight of one or more nonionic emulsifiers and dispersants, from 0 to 8% by weight of one or more ionic emulsifiers and dispersants, from 0 to 3% by weight of one or more thickeners and thixotropic agents.

In a preferred embodiment, the oil suspension concentrate according to the invention comprises
a) one or more herbicidally active compounds of the formula (I) and/or salts thereof, preferably A1.1 to A18.2,
b) one or more organic solvents from the group of the aliphatic or aromatic hydrocarbons and the vegetable oils, such as rapeseed oil methyl ester, and
c) a safener selected from the group consisting of S1-1, S1-6, S1-9, S2-1, S3-1 and S-4.

Particularly preferred examples which may be mentioned are oil suspension concentrates according to the invention comprising the components listed below; however, this does not limit the invention. Here, Solvesso is a solvent from the Solvesso® series, preferably Solvesso® 200, Bayol is a solvent from the Bayol® series, preferably Bayol® 82, Edenor=Edenor® MESU and Actirob=Actirob® B.

Solvesso+A1.1, Bayol+A1.1, Edenor+A1.1, Actirob B+A1.1, Solvesso+A2.1, Bayol+A2.1, Edenor+A2.1, Actirob B+A2.1, Solvesso+A3.1, Bayol+A3.1, Edenor+A3.1, Actirob B+A3.1, Solvesso+A4.1, Bayol+A4.1, Edenor+A4.1, Actirob B+A4.1, Solvesso+A5.1, Bayol+A5.1, Edenor+A5.1, Actirob B+A5.1, Solvesso+A6.1, Bayol+A6.1, Edenor+A6.1, Actirob B+A6.1, Solvesso+A7.1, Bayol+A7.1, Edenor+A7.1, Actirob B+A7.1, Solvesso+A8.1, Bayol+A8.1, Edenor+A8.1, Actirob B+A8.1, Solvesso+A9.1, Bayol+A9.1, Edenor+A9.1, Actirob B+A9.1, Solvesso+A10.1, Bayol+A10.1, Edenor+A10.1, Actirob B+A10.1, Solvesso+A11.1, Bayol+A11.1, Edenor+A11.1, Actirob B+A11.1, Solvesso+A12.1, Bayol+A12.1, Edenor+A12.1, Actirob B+A12.1, Solvesso+A13.1, Bayol+A13.1, Edenor+A13.1, Actirob B+A13.1, Solvesso+A14.1, Bayol+A14.1, Edenor+A14.1, Actirob B+A14.1, Solvesso+A15.1, Bayol+A15.1, Edenor+A15.1, Actirob B+A15.1, Solvesso+A16.1, Bayol+A16.1, Edenor+A16.1, Actirob B+A16.1, Solvesso+A17.1, Bayol+A17.1, Edenor+A17.1, Actirob B+A17.1, Solvesso+A18.1, Bayol+A18.1, Edenor+A18.1, Actirob B+A18.1.

Solvesso+A1.2, Bayol+A1.2, Edenor+A1.2, Actirob B+A1.2, Solvesso+A2.2, Bayol+A2.2, Edenor+A2.2, Actirob B+A2.2, Solvesso+A3.2, Bayol+A3.2, Edenor+A3.2, Actirob B+A3.2, Solvesso+A4.2, Bayol+A4.2, Edenor+A4.2, Actirob B+A4.2, Solvesso+A5.2, Bayol+A5.2, Edenor+A5.2, Actirob B+A5.2, Solvesso+A6.2, Bayol+A6.2, Edenor+A6.2, Actirob B+A6.2, Solvesso+A7.2, Bayol+A7.2, Edenor+A7.2, Actirob B+A7.2, Solvesso+A8.2, Bayol+A8.2, Edenor+A8.2, Actirob B+A8.2, Solvesso+A9.2, Bayol+A9.2, Edenor+A9.2, Actirob B+A9.2, Solvesso+A10.2, Bayol+A10.2, Edenor+A10.2, Actirob B+A10.2, Solvesso+A11.2, Bayol+A11.2, Edenor+A11.2, Actirob B+A11.2, Solvesso+A12.2, Bayol+A12.2, Edenor+A12.2, Actirob B+A12.2, Solvesso+A13.2, Bayol+A13.2, Edenor+A13.2, Actirob B+A13.2, Solvesso+A14.2, Bayol+A14.2, Edenor+A14.2, Actirob B+A14.2, Solvesso+A15.2, Bayol+A15.2, Edenor+A15.2, Actirob B+A15.2, Solvesso+A16.2, Bayol+A16.2, Edenor+A16.2, Actirob B+A16.2, Solvesso+A17.2, Bayol+A17.2, Edenor+A17.2, Actirob B+A17.2, Solvesso+A18.2, Bayol+A18.2, Edenor+A18.2, Actirob B+A18.2.

Solvesso+S1-1+A1.1, Bayol+S1-1+A1.1, Edenor+S1-1+A1.1, Actirob B+S1-1+A1.1, Solvesso+S1-1+A2.1, Bayol+S1-1+A2.1, Edenor+S1-1+A2.1, Actirob B+S1-1+A2.1, Solvesso+S1-1+A3.1, Bayol+S1-1+A3.1, Edenor+S1-1+A3.1, Actirob B+S1-1+A3.1, Solvesso+S1-1+A4.1, Bayol+S1-1+A4.1, Edenor+S1-1+A4.1, Actirob B+S1-1+A4.1, Solvesso+S1-1+A5.1, Bayol+S1-1+A5.1, Edenor+S1-1+A5.1, Actirob B+S1-1+A5.1, Solvesso+S1-1+A6.1, Bayol+S1-1+A6.1, Edenor+S1-1+A6.1, Actirob B+S1-1+A6.1, Solvesso+S1-1+A7.1, Bayol+S1-1+A7.1, Edenor+S1-1+A7.1, Actirob B+S1-1+A7.1, Solvesso+S1-1+A8.1, Bayol+S1-1+A8.1, Edenor+S1-1+A8.1, Actirob B+S1-1+A8.1, Solvesso+S1-1+A9.1, Bayol+S1-1+A9.1, Edenor+S1-1+A9.1, Actirob B+S1-1+A9.1, Solvesso+S1-1+A10.1, Bayol+S1-1+A10.1, Edenor+S1-1+A10.1, Actirob B+S1-1+A10.1, Solvesso+S1-1+A11.1, Bayol+S1-1+A11.1, Edenor+S1-1+A11.1, Actirob B+S1-1+A11.1, Solvesso+S1-1+A12.1, Bayol+S1-1+A12.1, Edenor+S1-1+A12.1, Actirob B+S1-1+A12.1, Solvesso+S1-1+A13.1, Bayol+S1-1+A13.1, Edenor+S1-1+A13.1, Actirob B+S1-1+A13.1, Solvesso+S1-1+A14.1, Bayol+S1-1+A14.1, Edenor+S1-1+A14.1, Actirob B+S1-1+A14.1, Solvesso+S1-1+A15.1, Bayol+S1-1+A15.1, Edenor+S1-1+A15.1, Actirob B+S1-1+A15.1, Solvesso+S1-1+A16.1, Bayol+S1-1+A16.1, Edenor+S1-1+A16.1, Actirob B+S1-1+A16.1, Solvesso+S1-1+A17.1, Bayol+S1-1+A17.1, Edenor+S1-1+A17.1, Actirob B+S1-1+A17.1, Solvesso+S1-1+A18.1, Bayol+S1-1+A18.1, Edenor+S1-1+A18.1, Actirob B+S1-1+A18.1.

Solvesso+S1-1+A1.2, Bayol+S1-1+A1.2, Edenor+S1-1+A1.2, Actirob B+S1-1+A1.2, Solvesso+S1-1+A2.2, Bayol+S1-1+A2.2, Edenor+S1-1+A2.2, Actirob B+S1-1+A2.2, Solvesso+S1-1+A3.2, Bayol+S1-1+A3.2, Edenor+S1-1+A3.2, Actirob B+S1-1+A3.2, Solvesso+S1-1+A4.2, Bayol+S1-1+A4.2, Edenor+S1-1+A4.2, Actirob B+S1-1+A4.2, Solvesso+S1-1+A5.2, Bayol+S1-1+A5.2, Edenor+S1-1+A5.2, Actirob B+S1-1+A5.2, Solvesso+S1-1+A6.2, Bayol+S1-1+A6.2, Edenor+S1-1+A6.2, Actirob B+S1-1+A6.2, Solvesso+S1-1+A7.2, Bayol+S1-1+A7.2, Edenor+S1-1+A7.2, Actirob B+S1-1+A7.2, Solvesso+S1-1+A8.2, Bayol+S1-1+A8.2, Edenor+S1-1+A8.2, Actirob B+S1-1+A8.2, Solvesso+S1-1+A9.2, Bayol+S1-1+A9.2, Edenor+S1-1+A9.2, Actirob B+S1-1+A9.2, Solvesso+S1-1+A10.2, Bayol+S1-1+A10.2, Edenor+S1-1+A10.2, Actirob B+S1-1+A10.2, Solvesso+S1-1+A11.2, Bayol+S1-1+A11.2, Edenor+S1-1+A11.2, Actirob B+S1-1+A11.2, Solvesso+S1-1+A12.2, Bayol+S1-1+A12.2, Edenor+S1-1+A12.2, Actirob B+S1-1+A12.2, Solvesso+S1-1+A13.2, Bayol+S1-1+A13.2, Edenor+S1-1+A13.2, Actirob B+S1-1+A13.2, Solvesso+S1-1+A14.2, Bayol+S1-1+A14.2, Edenor+S1-1+A14.2, Actirob B+S1-1+A14.2, Solvesso+S1-1+A15.2, Bayol+S1-1+A15.2, Edenor+S1-1+A15.2, Actirob B+S1-1+A15.2, Solvesso+S1-1+A16.2, Bayol+S1-1+A16.2, Edenor+S1-1+A16.2, Actirob B+S1-1+A16.2, Solvesso+S1-1+A17.2, Bayol+S1-1+A17.2, Edenor+S1-1+A17.2, Actirob B+S1-1+A17.2, Solvesso+S1-1+A18.2, Bayol+S1-1+A18.2, Edenor+S1-1+A18.2, Actirob B+S1-1+A18.2.

Solvesso+S1-6+A1.1, Bayol+S1-6+A1.1, Edenor+S1-6+A1.1, Actirob B+S1-6+A1.1, Solvesso+S1-6+A2.1, Bayol+S1-6+A2.1, Edenor+S1-6+A2.1, Actirob B+S1-6+A2.1, Solvesso+S1-6+A3.1, Bayol+S1-6+A3.1, Edenor+S1-6+A3.1, Actirob B+S1-6+A3.1, Solvesso+S1-6+A4.1, Bayol+S1-6+A4.1, Edenor+S1-6+A4.1, Actirob B+S1-6+A4.1, Solvesso+S1-6+A5.1, Bayol+S1-6+A5.1, Edenor+S1-6+A5.1, Actirob B+S1-6+A5.1, Solvesso+S1-6+A6.1, Bayol+S1-6+A6.1, Edenor+S1-6+A6.1, Actirob B+S1-6+A6.1, Solvesso+S1-6+A7.1, Bayol+S1-6+A7.1, Edenor+S1-6+A7.1, Actirob B+S1-6+A7.1, Solvesso+S1-6+A8.1, Bayol+S1-6+A8.1, Edenor+Si-6+A8.1, Actirob B+S1-6+A8.1, Solvesso+S1-6+A9.1, Bayol+S1-6+A9.1, Edenor+S1-6+A9.1, Actirob B+S1-6+A9.1, Solvesso+S1-6+A10.1, Bayol+S1-6+A10.1, Edenor+S1-6+A0.1, Actirob B+S1-6+A10.1, Solvesso+S1-6+A11.1, Bayol+S1-6+A11.1, Edenor+S1-6+A11.1, Actirob B+S1-6+A11.1, Solvesso+S1-6+A12.1, Bayol+S1-6+A12.1, Edenor+S1-6+A12.1, Actirob B+S1-6+A12.1, Solvesso+S1-6+A13.1, Bayol+S1-6+A13.1, Edenor+S1-6+A13.1, Actirob B+S1-6+A13.1, Solvesso+S1-6+A14.1, Bayol+S1-6+A14.1, Edenor+S1-6+A14.1, Actirob B+S1-6+A14.1, Solvesso+S1-6+A15.1, Bayol+S1-6+A15.1, Edenor+S1-6+A15.1, Actirob B+S1-6+A15.1, Solvesso+S1-6+A16.1, Bayol+S1-6+A16.1, Edenor+S1-6+A16.1, Actirob B+S1-6+A16.1, Solvesso+S1-6+A17.1, Bayol+S1-6+A17.1, Edenor+S1-6+A17.1, Actirob B+S1-6+A17.1, Solvesso+S1-6+A18.1, Bayol+S1-6+A18.1, Edenor+S1-6+A18.1, Actirob B+S1-6+A18.1.

Solvesso+S1-6+A1.2, Bayol+S1-6+A1.2, Edenor+S1-6+A1.2, Actirob B+S1-6+A1.2, Solvesso+S1-6+A2.2, Bayol+S1-6+A2.2, Edenor+S1-6+A2.2, Actirob B+S1-6+A2.2, Solvesso+S1-6+A3.2, Bayol+S1-6+A3.2, Edenor+S1-6+A3.2, Actirob B+S1-6+A3.2, Solvesso+S1-6+A4.2, Bayol+S1-6+A4.2, Edenor+S1-6+A4.2, Actirob B+S1-6+A4.2, Solvesso+S1-6+A5.2, Bayol+S1-6+A5.2, Edenor+S1-6+A5.2, Actirob B+S1-6+A5.2, Solvesso+S1-6+A6.2, Bayol+S1-6+A6.2, Edenor+S1-6+A6.2, Actirob B+S1-6+A6.2, Solvesso+S1-6+A7.2, Bayol+S1-6+A7.2, Edenor+S1-6+A7.2, Actirob B+S1-6+A7.2, Solvesso+S1-6+. A8.2, Bayol+S1-6+A8.2, Edenor+S1-6+A8.2, Actirob B+S1-6+A8.2, Solvesso+S1-6+A9.2, Bayol+S1-6+A9.2, Edenor+S1-6+A9.2, Actirob B+S1-6+A9.2, Solvesso+S1-6+A10.2, Bayol+S1-6+A10.2, Edenor+S1-6+A10.2, Actirob B+S1-6+A10.2, Solvesso+S1-6+A11.2, Bayol+S1-6+A11.2, Edenor+S1-6+A11.2, Actirob B+S1-6+A11.2, Solvesso+S1-6+A12.2, Bayol+S1-6+A12.2, Edenor+S1-6+A12.2, Actirob B+S1-6+A12.2, Solvesso+S1-6+A13.2, Bayol+S1-6+A13.2, Edenor+S1-6+A13.2, Actirob B+S1-6+A13.2, Solvesso+S1-6+A14.2, Bayol+S1-6+A14.2, Edenor+S1-6+A14.2, Actirob B+S1-6+A14.2, Solvesso+S1-6+A15.2, Bayol+S1-6+A15.2, Edenor+S1-6+A15.2, Actirob B+S1-6+A15.2, Solvesso+S1-6+A16.2, Bayol+S1-6+A16.2, Edenor+S1-6+A16.2, Actirob B+S1-6+A16.2, Solvesso+S1-6+A17.2, Bayol+S1-6+A17.2, Edenor+S1-6+A17.2, Actirob B+S1-6+A17.2, Solvesso+S1-6+A18.2, Bayol+S1-6+A18.2, Edenor+S1-6+A18.2, Actirob B+S1-6+A18.2.

Solvesso+S1-9+A1.1, Bayol+S1-9+A1.1, Edenor+S1-9+A1.1, Actirob B+S1-9+A1.1, Solvesso+S1-9+A2.1, Bayol+S1-9+A2.1, Edenor+S1-9+A2.1, Actirob B+S1-9+A2.1, Solvesso+S1-9+A3.1, Bayol+S1-9+A3.1, Edenor+S1-9+A3.1, Actirob B+S1-9+A3.1, Solvesso+S1-9+A4.1, Bayol+S1-9+A4.1, Edenor+S1-9+A4.1, Actirob B+S1-9+A4.1, Solvesso+S1-9+A5.1, Bayol+S1-9+A5.1, Edenor+S1-9+A5.1, Actirob B+S1-9+A5.1, Solvesso+S1-9+A6.1, Bayol+S1-9+A6.1, Edenor+S1-9+A6.1, Actirob B+S1-9+A6.1, Solvesso+S1-9+A7.1, Bayol+S1-9+A7.1, Edenor+S1-9+A7.1, Actirob B+S1-9+A7.1, Solvesso+S1-9+A8.1, Bayol+S1-9+A8.1, Edenor+S1-9+A8.1, Actirob B+S1-9+A8.1, Solvesso+S1-9+A9.1, Bayol+S1-9+A9.1, Edenor+S1-9+A9.1, Actirob B+S1-9+A9.1, Solvesso+S1-9+A10.1, Bayol+S1-9+A10.1, Edenor+S1-9+A10.1, Actirob B+S1-9+A10.1, Solvesso+S1-9+A111.1, Bayol+S1-9+A11.1, Edenor+S1-9+A11.1, Actirob B+S1-9+A11.1, Solvesso+S1-9+A12.1, Bayol+S1-9+A12.1, Edenor+S1-9+A12.1, Actirob B+S1-9+A12.1, Solvesso+S1-9+A13.1, Bayol+S1-9+A13.1, Edenor+S1-9+A13.1, Actirob B+S1-9+A13.1, Solvesso+S1-9+A14.1, Bayol+S1-9+A14.1, Edenor+S1-9+A14.1, Actirob B+S1-9+A14.1, Solvesso+S1-9+A15.1, Bayol+S1-9+A15.1, Edenor+S1-9+A15.1, Actirob B+S1-9+A15.1, Solvesso+S1-9+A16.1, Bayol+S1-9+A16.1, Edenor+S1-9+A16.1, Actirob B+S1-9+A16.1, Solvesso+S1-9+A17.1, Bayol+S1-9+A17.1, Edenor+S1-9+A17.1, Actirob B+S1-9+A17.1, Solvesso+S1-9+A18.1, Bayol+S1-9+A18.1, Edenor+S1-9+A18.1, Actirob B+S1-9+A18.1.

Solvesso+S1-9+A1.2, Bayol+S1-9+A1.2, Edenor+S1-9+A1.2, Actirob B+S1-9+A1.2, Solvesso+S1-9+A2.2, Bayol+S1-9+A2.2, Edenor+S1-9+A2.2, Actirob B+S1-9+A2.2, Solvesso+S1-9+A3.2, Bayol+S1-9+A3.2, Edenor+S1-9+A3.2, Actirob B+S1-9+A3.2, Solvesso+S1-9+A4.2, Bayol+S1-9+A4.2, Edenor+S1-9+A4.2, Actirob B+S1-9+A4.2, Solvesso+S1-9+A5.2, Bayol+S1-9+A5.2, Edenor+S1-9+A5.2, Actirob B+S1-9+A5.2, Solvesso+S1-9+A6.2, Bayol+S1-9+A6.2, Edenor+S1-9+A6.2, Actirob B+S1-9+A6.2, Solvesso+S1-9+A7.2, Bayol+S1-9+A7.2, Edenor+S1-9+A7.2, Actirob B+S1-9+A7.2, Solvesso+S1-9+A8.2, Bayol+S1-9+A8.2, Edenor+S1-9+A8.2, Actirob B+S1-9+A8.2, Solvesso+S1-9+A9.2, Bayol+S1-9+A9.2, Edenor+S1-9+A9.2, Actirob B+S1-9+A9.2, Solvesso+S1-9+A10.2, Bayol+S1-9+A10.2, Edenor+S1-9+A10.2, Actirob B+S1-9+A10.2, Solvesso+S1-9+A11.2, Bayol+S1-9+A11.2, Edenor+S1-9+A11.2, Actirob B+S1-9+A11.2, Solvesso+S1-9+A12.2, Bayol+S1-9+A12.2, Edenor+S1-9+A12.2, Actirob B+S1-9+A12.2, Solvesso+S1-9+A13.2, Bayol+S1-9+A13.2, Edenor+S1-9+A13.2, Actirob B+S1-9+A13.2, Solvesso+S1-9+A14.2, Bayol+S1-9+A14.2, Edenor+S1-9+A14.2, Actirob B+S1-9+A14.2, Solvesso+S1-9+A15.2, Bayol+S1-9+A15.2, Edenor+S1-9+A15.2, Actirob B+S1-9+A15.2, Solvesso+S1-9+A16.2, Bayol+S1-9+A16.2, Edenor+S1-9+A16.2, Actirob B+S1-9+A16.2, Solvesso+S1-9+A17.2, Bayol+S1-9+A17.2, Edenor+S1-9+A17.2, Actirob B+S1-9+A17.2, Solvesso+S1-9+A18.2, Bayol+S1-9+A18.2, Edenor+S1-9+A18.2, Actirob B+S1-9+A18.2.

Solvesso+S2-1+A1.1, Bayol+S2-1+A1.1, Edenor+S2-1+A1.1, Actirob B+S2-1+A1.1, Solvesso+S2-1+A2.1, Bayol+S2-1+A2.1, Edenor+S2-1+A2.1, Actirob B+S2-1+A2.1, Solvesso+S2-1+A3.1, Bayol+S2-1+A3.1, Edenor+S2-1+A3.1, Actirob B+S2-1+A3.1, Solvesso+S2-1+A4.1, Bayol+S2-1+A4.1, Edenor+S2-1+A4.1, Actirob B+S2-1+A4.1, Solvesso+S2-1+A5.1, Bayol+S2-1+A5.1, Edenor+S2-1+A5.1, Actirob B+S2-1+A5.1, Solvesso+S2-1+A6.1, Bayol+S2-1+A6.1, Edenor+S2-1+A6.1, Actirob B+S2-1+A6.1, Solvesso+S2-1+A7.1, Bayol+S2-1+A7.1, Edenor+S2-1+A7.1, Actirob B+S2-1+A7.1, Solvesso+S2-1+A8.1, Bayol+S2-1+A8.1, Edenor+S2-1+A8.1, Actirob B+S2-1+A8.1, Solvesso+S2-1+A9.1, Bayol+S2-1+A9.1, Edenor+S2-1+A9.1, Actirob B+S2-1+A9.1, Solvesso+S2-1+A10.1, Bayol+S2-1+A10.1, Edenor+S2-1+A10.1, Actirob B+S2-1+A10.1, Solvesso+S2-1+A11.1, Bayol+S2-1+A11.1, Edenor+S2-1+A11.1, Actirob B+S2-1+A11.1, Solvesso+S2-1+A12.1, Bayol+S2-1+A12.1, Edenor+S2-1+A12.1, Actirob B+S2-1+A12.1, Solvesso+S2-1+A13.1, Bayol+S2-1+A13.1, Edenor+S2-1+A13.1, Actirob B+S2-1+A13.1, Solvesso+S2-1+A14.1, Bayol+S2-1+A14.1, Edenor+S2-1+A14.1, Actirob B+S2-1+A14.1, Solvesso+S2-1+A15.1, Bayol+S2-1+A15.1, Edenor+S2-1+A15.1, Actirob B+S2-1+A15.1, Solvesso+S2-1+A16.1, Bayol+S2-1+A16.1, Edenor+S2-1+A16.1, Actirob B+S2-1+A16.1, Solvesso+S2-1+A17.1, Bayol+S2-1+A17.1, Edenor+S2-1+A17.1, Actirob B+S2-1+A17.1, Solvesso+S2-1+A18.1, Bayol+S2-1+A18.1, Edenor+S2-1+A18.1, Actirob B+S2-1+A18.1.

Solvesso+S2-1+A1.2, Bayol+S2-1+A1.2, Edenor+S2-1+A1.2, Actirob B+S2-1+A1.2, Solvesso+S2-1+A2.2, Bayol+S2-1+A2.2, Edenor+S2-1+A2.2, Actirob B+S2-1+A2.2, Solvesso+S2-1+A3.2, Bayol+S2-1+A3.2, Edenor+S2-1+A3.2, Actirob B+S2-1+A3.2, Solvesso+S2-1+A4.2, Bayol+S2-1+A4.2, Edenor+S2-1+A4.2, Actirob B+S2-1+A4.2, Solvesso+S2-1+A5.2, Bayol+S2-1+A5.2, Edenor+S2-1+A5.2, Actirob B+S2-1+A5.2, Solvesso+S2-1+A6.2, Bayol+S2-1+A6.2, Edenor+S2-1+A6.2, Actirob B+S2-1+A6.2, Solvesso+S2-1+A7.2, Bayol+S2-1+A7.2, Edenor+S2-1+A7.2, Actirob B+S2-1+A7.2, Solvesso+S2-1+A8.2, Bayol+S2-1+A8.2, Edenor+S2-1+A8.2, Actirob B+S2-1+A8.2, Solvesso+S2-1+A9.2, Bayol+S2-1+A9.2, Edenor+S2-1+A9.2, Actirob B+S2-1+A9.2, Solvesso+S2-1+A10.2, Bayol+S2-1+A10.2, Edenor+S2-1+A10.2, Actirob B+S2-1+A10.2, Solvesso+S2-1+A11.2, Bayol+S2-1+A11.2, Edenor+S2-1+A11.2, Actirob B+S2-1+A11.2, Solvesso+S2-1+A12.2, Bayol+S2-1+A12.2, Edenor+S2-1+A12.2, Actirob B+S2-1+A12.2, Solvesso+S2-1+A13.2, Bayol+S2-1+A13.2, Edenor+S2-1+A13.2, Actirob B+S2-1+A13.2, Solvesso+S2-1+A14.2, Bayol+S2-1+A14.2, Edenor+S2-1+A14.2, Actirob B+S2-1+A14.2, Solvesso+S2-1+A15.2, Bayol+S2-1+A15.2, Edenor+S2-1+A15.2, Actirob B+S2-1+A15.2, Solvesso+S2-1+A16.2, Bayol+S2-1+A16.2, Edenor+S2-1+A16.2, Actirob B+S2-1+A16.2, Solvesso+S2-1+A17.2, Bayol+S2-1+A17.2, Edenor+S2-1+A17.2, Actirob B+S2-1+A17.2, Solvesso+S2-1+A18.2, Bayol+S2-1+A18.2, Edenor+S2-1+A18.2, Actirob B+S2-1+A18.2.

Solvesso+S3-1+A1.1, Bayol+S3-1+A1.1, Edenor+S3-1+A1.1, Actirob B+S3-1+A1.1, Solvesso+S3-1+A2.1, Bayol+S3-1+A2.1, Edenor+S3-1+A2.1, Actirob B+S3-1+A2.1, Solvesso+S3-1+A3.1, Bayol+S3-1+A3.1, Edenor+S3-1+A3.1, Actirob B+S3-1+A3.1, Solvesso+S3-1+A4.1, Bayol+S3-1+A4.1, Edenor+S3-1+A4.1, Actirob B+S3-1+A4.1, Solvesso+S3-1+A5.1, Bayol+S3-1+A5.1, Edenor+S3-1+A5.1, Actirob B+S3-1+A5.1, Solvesso+S3-1+A6.1, Bayol+S3-1+A6.1, Edenor+S3-1+A6.1, Actirob B+S3-1+A6.1, Solvesso+S3-1+A7.1, Bayol+S3-1+A7.1, Edenor+S3-1+A7.1, Actirob B+S3-1+A7.1, Solvesso+S3-1+A8.1, Bayol+S3-1+A8.1, Edenor+S3-1+A8.1, Actirob B+S3-1+A8.1, Solvesso+S3-1+A9.1, Bayol+S3-1+A9.1, Edenor+S3-1+A9.1, Actirob B+S3-1+A9.1, Solvesso+S3-1+A10.1, Bayol+S3-1+A10.1, Edenor+S3-1+A10.1, Actirob B+S3-1+A10.1, Solvesso+S3-1+A11.1, Bayol+S3-1+A11.1, Edenor+S3-1+A11.1, Actirob B+S3-1+A11.1, Solvesso+S3-1+A12.1, Bayol+S3-1+A12.1, Edenor+S3-1+A12.1, Actirob B+S3-1+A12.1, Solvesso+S3-1+A13.1, Bayol+S3-1+A13.1, Edenor+S3-1+A13.1, Actirob B+S3-1+A13.1, Solvesso+S3-1+A14.1, Bayol+S3-1+A14.1, Edenor+S3-1+A14.1, Actirob B+S3-1+A14.1, Solvesso+S3-1+A15.1, Bayol+S3-1+A15.1, Edenor+S3-1+A15.1, Actirob B+S3-1+A15.1, Solvesso+S3-1+A16.1, Bayol+S3-1+A16.1, Edenor+S3-1+A16.1, Actirob B+S3-1+A16.1, Solvesso+S3-1+A17.1, Bayol+S3-1+A17.1, Edenor+S3-1+A17.1, Actirob B+S3-1+A17.1, Solvesso+S3-1+A18.1, Bayol+S3-1+A18.1, Edenor+S3-1+A18.1, Actirob B+S3-1+A18.1.

Solvesso+S3-1+A1.2, Bayol+S3-1+A1.2, Edenor+S3-1+A1.2, Actirob B+S3-1+A1.2, Solvesso+S3-1+A2.2, Bayol+S3-1+A2.2, Edenor+S3-1+A2.2, Actirob B+S3-1+A2.2, Solvesso+S3-1+A3.2, Bayol+S3-1+A3.2, Edenor+S3-1+A3.2, Actirob B+S3-1+A3.2, Solvesso+S3-1+A4.2, Bayol+S3-1+A4.2, Edenor+S3-1+A4.2, Actirob B+S3-1+A4.2, Solvesso+S3-1+A5.2, Bayol+S3-1+A5.2, Edenor+S3-1+A5.2, Actirob B+S3-1+A5.2, Solvesso+S3-1+A6.2, Bayol+S3-1+A6.2, Edenor+S3-1+A6.2, Actirob B+S3-1+A6.2, Solvesso+S3-1+A7.2, Bayol+S3-1+A7.2, Edenor+S3-1+A7.2, Actirob B+S3-1+A7.2, Solvesso+S3-1+A8.2, Bayol+S3-1+A8.2, Edenor+S3-1+A8.2, Actirob B+S3-1+A8.2, Solvesso+S3-1+A9.2, Bayol+S3-1+A9.2, Edenor+S3-1+A9.2, Actirob B+S3-1+A9.2, Solvesso+S3-1+A10.2, Bayol+S3-1+A10.2, Edenor+S3-1+A10.2, Actirob B+S3-1+A10.2, Solvesso+S3-1+A11.2, Bayol+S3-1+A11.2, Edenor+S3-1+A11.2, Actirob B+S3-1+A11.2, Solvesso+S3-1+A12.2, Bayol+S3-1+A12.2, Edenor+S3-1+A12.2, Actirob B+S3-1+A12.2, Solvesso+S3-1+A13.2, Bayol+S3-1+A13.2, Edenor+S3-1+A13.2, Actirob B+S3-1+A13.2, Solvesso+S3-1+A14.2, Bayol+S3-1+A14.2, Edenor+S3-1+A14.2, Actirob B+S3-1+A14.2, Solvesso+S3-1+A15.2, Bayol+S3-1+A15.2, Edenor+S3-1+A15.2, Actirob B+S3-1+A15.2, Solvesso+S3-1+A16.2, Bayol+S3-1+A16.2, Edenor+S3-1+A16.2, Actirob B+S3-1+A16.2, Solvesso+S3-1+A17.2, Bayol+S3-1+A17.2, Edenor+S3-1+A17.2, Actirob B+S3-1+A17.2, Solvesso+S3-1+A18.2, Bayol+S3-1+A18.2, Edenor+S3-1+A18.2, Actirob B+S3-1+A18.2.

Solvesso+S-4+A1.1, Bayol+S-4+A1.1, Edenor+S-4+A1.1, Actirob B+S-4+A1.1, Solvesso+S-4+A2.1, Bayol+S-4+A2.1, Edenor+S-4+A2.1, Actirob B+S-4+A2.1, Solvesso+S-4+A3.1, Bayol+S-4+A3.1, Edenor+S-4+A3.1, Actirob B+S-4+A3.1, Solvesso+S-4+A4.1, Bayol+S-4+A4.1, Edenor+S-4+A4.1, Actirob B+S-4+A4.1, Solvesso+S-4+A5.1, Bayol+S-4+A5.1, Edenor+S-4+A5.1, Actirob B+S-4+A5.1, Solvesso+S-4+A6.1, Bayol+S-4+A6.1, Edenor+S-4+A6.1, Actirob B+S-4+A6.1, Solvesso+S-4+A7.1, Bayol+S-4+A7.1, Edenor+S-4+A7.1, Actirob B+S-4+A7.1, Solvesso+S-4+A8.1, Bayol+S-4+A8.1, Edenor+S-4+A8.1, Actirob B+S-4+A8.1, Solvesso+S-4+A9.1, Bayol+S-4+A9.1, Edenor+S-4+A9.1, Actirob B+S-4+A9.1, Solvesso+S-4+A10.1, Bayol+S-4+A10.1, Edenor+S-4+A10.1, Actirob B+S-4+A10.1, Solvesso+S-4+A11.1, Bayol+S-4+A11.1, Edenor+S-4+A11.1, Actirob B+S-4+A11.1, Solvesso+S-4+A12.1, Bayol+S-4+A12.1, Edenor+S-4+A12.1, Actirob B+S-4+A12.1, Solvesso+S-4+A13.1, Bayol+S-4+A13.1, Edenor+S-4+A13.1, Actirob B+S-4+A13.1, Solvesso+S-4+A14.1, Bayol+S-4+A14.1, Edenor+S-4+A14.1, Actirob B+S-4+A14.1, Solvesso+S-4+A15.1, Bayol+S-4+A15.1, Edenor+S-4+A15.1, Actirob B+S-4+A15.1, Solvesso+S-4+A16.1, Bayol+S-4+A16.1, Edenor+S-4+A16.1, Actirob B+S-4+A16.1, Solvesso+S-4+A17.1, Bayol+S-4+A17.1, Edenor+S-4+A17.1, Actirob B+S-4+A17.1, Solvesso+S-4+A18.1, Bayol+S-4+A18.1, Edenor+S-4+A18.1, Actirob B+S-4+A18.1.

Solvesso+S-4+A1.2, Bayol+S-4+A1.2, Edenor+S-4+A1.2, Actirob B+S-4+A1.2, Solvesso+S-4+A2.2, Bayol+S-4+A2.2, Edenor+S-4+A2.2, Actirob B+S-4+A2.2, Solvesso+S-4+A3.2, Bayol+S-4+A3.2, Edenor+S-4+A3.2, Actirob B+S-4+A3.2, Solvesso+S-4+A4.2, Bayol+S-4+A4.2, Edenor+S-4+A4.2, Actirob B+S-4+A4.2, Solvesso+S-4+A5.2, Bayol+S-4+A5.2, Edenor+S-4+A5.2, Actirob B+S-4+A5.2, Solvesso+S-4+A6.2, Bayol+S-4+A6.2, Edenor+S-4+A6.2, Actirob B+S-4+A6.2, Solvesso+S-4+A7.2, Bayol+S-4+A7.2, Edenor+S-4+A7.2, Actirob B+S-4+A7.2, Solvesso+S-4+A8.2, Bayol+S-4+A8.2, Edenor+S-4+A8.2, Actirob B+S-4+A8.2, Solvesso+S-4+A9.2, Bayol+S-4+A9.2, Edenor+S-4+A9.2, Actirob B+S-4+A9.2, Solvesso+S-4+A10.2, Bayol+S-4+A10.2, Edenor+S-4+A10.2, Actirob B+S-4+A10.2, Solvesso+S-4+A11.2, Bayol+S-4+A11.2, Edenor+S-4+A11.2, Actirob B+S-4+A11.2, Solvesso+S-4+A12.2, Bayol+S-4+A12.2, Edenor+S-4+A12.2, Actirob B+S-4+A12.2, Solvesso+S-4+A13.2, Bayol+S-4+A13.2, Edenor+S-4+A13.2, Actirob B+S-4+A13.2, Solvesso+S-4+A14.2, Bayol+S-4+A14.2, Edenor+S-4+A14.2, Actirob B+S-4+A14.2, Solvesso+S-4+A15.2, Bayol+S-4+A15.2, Edenor+S-4+A15.2, Actirob B+S-4+A15.2, Solvesso+S-4+A16.2, Bayol+S-4+A16.2, Edenor+S-4+A16.2, Actirob B+S-4+A16.2, Solvesso+S-4+A17.2, Bayol+S-4+A17.2, Edenor+S-4+A17.2, Actirob B+S-4+A17.2, Solvesso+S-4+A18.2, Bayol+S-4+A18.2, Edenor+S-4+A18.2, Actirob B+S-4+A18.2.

All of the above combinations may also comprise one or more agrochemically active compounds (e), in particular those selected from the group consisting of (E1), (E2), (E3), (E4), (E5), (E6), (E7), (E8), (E9), (E10), (E11), (E12), (E13), (E14), (E15), (E16), (E17), (E18), (E19), (E20), (E21), (E22), (E23), (E24), (E25), (E26), (E27), (E28) and (E29).

The above combinations may furthermore also comprise one or more sulfosuccinates d) and/or one or more inorganic salts f), and also customary auxiliaries and additives g).

If the oil suspension concentrates according to the invention comprise, as component a), a plurality of thienylsulfonamides, for example mixtures of thienylsulfonamides of the formula (I) or (II) and/or their salts, at least one of the thienylsulfonamides is present in suspended form, but it is also possible for all thienylsulfonamides to be present in suspended form.

The oil suspension concentrates according to the invention can be prepared by known processes, for example by mixing the components. Thus, it is possible, for example, to prepare a premix by dissolving the optional sulfosuccinate d) in the organic solvent b) and, if appropriate, adding further auxiliaries and additives g) to this solution. Any soluble agrochemically active compounds c) and e) used are then dissolved in the premix. Once this dissolution process has ended, solid thienylsulfonamide a) and, if appropriate, any insoluble active compounds c) and e) used are suspended in the mixture. The coarse suspension is, if appropriate after pregrinding, subjected to fine grinding.

In another embodiment, solid thienylsulfonamide a) and, if appropriate, any insoluble components c), e) and g) used are suspended in the organic solvent b) which optionally contains a sulfosuccinate d) and subjected to grinding. Any soluble active compounds c) and e) used and any auxiliaries and additives from g) which do not require grinding or are not required for the grinding process are added after grinding.

To prepare the mixtures, it is possible to use customary mixing apparatus which, if required, are thermostatted. For pregrinding, it is possible to use, for example, high-pressure homogenizers or mills operating by the rotor-stator principle, such as Ultraturrax homogenizers, for example those from IKA, or toothed colloid mills, for example from Puck. For fine grinding, it is possible to use, for example, bead mills which operate batch-wise, for example from Drais, or bead mills which operate continuously, for example from Bachofen. The preparation process can be adapted to the properties of the components employed and to technical and safety requirements and to economical considerations, and pregrinding and even fine grinding may be dispensed with, if required.

The components a) to f) used for the preparation may comprise water as a minor component which is then also found in the oil suspension concentrates according to the invention. Accordingly, the oil suspension concentrates according to the invention may comprise small amounts of water, in general from 0 to 5% by weight. Preferably, the oil suspension concentrates according to the invention are not subjected to any drying.

For application, the oil suspension concentrates according to the invention may, if required, be diluted to herbicidal compositions in a customary manner (using, for example, water), to give, for example, suspensions, emulsions, suspoemulsions or solutions, preferably suspoemulsions or emulsions. It may be advantageous to add further agrochemically active compounds (for example tank mix components in the form of appropriate formulations) and/or auxiliaries and additives customary for application, for example self-emulsifying oils, such as vegetable oils or paraffin oils, and/or fertilizers to the spray liquors obtained. Accordingly, the present invention also provides such herbicidal compositions based on the oil suspension concentrates according to the invention.

The herbicidal compositions according to the invention have outstanding herbicidal activity against a broad spectrum of economically important monocotyledonous and dicotyledonous harmful plants. Even perennial weeds which produce shoots from rhizomes, rootstocks or other perennial organs and which are difficult to control are controlled well. In this context, it does not matter whether the substances are applied before sowing, pre-emergence or post-emergence. Specific examples may be mentioned of some representatives of the monocotyledonous and dicotyledonous weed flora which can be controlled by the herbicidal compositions according to the invention, without the enumeration being a restriction to certain species.

Examples of monocotyledonous weed species on which the herbicidal compositions act efficiently are Apera spica venti, Avena spp., Alopecurus spp., Brachiaria spp., Digitaria spp., Lolium spp., Echinochloa spp., Panicum spp., Phalaris spp., Poa spp., Setaria spp. and Bromus spp. such as Bromus catharticus, Bromus secalinus, Bromus erectus, Bromus tectorum and Bromus japonicus, and Cyperus species from the annual group, and, among the perennial species, Agropyron, Cynodon, Imperata and Sorghum and also perennial Cyperus species.

In the case of the dicotyledonous weed species, the spectrum of action extends to genera such as, for example, Abutilon spp., Amaranthus spp., Chenopodium spp., Chrysanthemum spp., Galium spp. such as Galium aparine, Ipomoea spp., Kochia spp., Lamium spp., Matricaria spp., Pharbitis spp., Polygonum spp., Sida spp., Sinapis spp., Solanum spp., Stellaria spp., Veronica spp. and Viola spp., Xanthium spp., among the annuals, and Convolvulus, Cirsium, Rumex and Artemisia in the case of the perennial weeds.

The compositions according to the invention also act outstandingly efficiently on harmful plants which are found under the specific cultures in rice, such as, for example, Echinochloa, Sagittaria, Alisma, Eleocharis, Scirpus and Cyperus.

If the herbicidal compositions according to the invention are applied to the soil surface before germination, the weed seedlings are either prevented completely from emerging or else the weeds grow until they have reached the cotyledon stage, but then their growth stops, and, eventually, after three to four weeks have elapsed, they die completely.

If the herbicidal compositions according to the invention are applied post-emergence to the green parts of the plants, growth likewise stops drastically a very short time after the treatment, and the weed plants remain at the growth stage of the point of time of application, or they die completely after a certain time, so that in this manner competition by the weeds, which is harmful to the crop plants, is eliminated very early and in a sustained manner.

The herbicidal compositions according to the invention are distinguished by a rapidly commencing and long-lasting herbicidal action. As a rule, the rainfastness of the active substances in the combinations according to the invention is advantageous. A particular advantage is that the dosages used in the herbicidal compositions and the effective dosages of herbicidal compounds can be adjusted to such a low level that their soil action is optimally low. This not only allows them to be employed in sensitive crops in the first place, but groundwater contaminations are virtually avoided. The active compound combination according to the invention allows the required application rate of the active substances to be reduced considerably.

The abovementioned properties and advantages are necessary for weed control practice to keep agricultural crops free from undesired competing plants, and thus to ensure and/or increase yield levels from the qualitative and quantitative angle. These novel compositions markedly exceed the technical state of the art with a view to the properties described.

While the herbicidal compositions according to the invention have an outstanding herbicidal activity against monocotyledonous and dicotyledonous weeds, crop plants of economically important crops, for example dicotyledonous crops such as soybean, cotton, oilseed rape, sugar beet, or graminaceous crops such as wheat, barley, rye, oats, millet, rice or corn, are damaged only to a minor extent, if at all. This is why the present compounds are highly suitable for the selective control of undesired plant growth in plantations of agricultural crops or of ornamentals.

In addition, the herbicidal compositions according to the invention have outstanding growth-regulatory properties in crop plants. They engage in the plants' metabolism in a regulatory manner and can thus be employed for provoking direct effects on plant constituents and to facilitate harvesting such as, for example, by triggering desiccation and stunted growth. Moreover, they are also suitable for the general control and inhibition of undesired vegetative growth without simultaneously destroying the plants. Inhibition of vegetative growth is very important in a large number of monocotyledonous and dicotyledonous crops since lodging can thus be reduced, or prevented completely.

By virtue of their herbicidal and plant-growth-regulatory properties, the herbicidal compositions according to the invention can also be employed for controlling harmful plants in crops of genetically modified plants which are known or yet to be developed. As a rule, the recombinant plants are distinguished by specific advantageous characteristics, for example by resistances to certain pesticides, in particular certain herbicides, resistances to plant diseases or the causative organisms of plant diseases such as specific insects or microorganisms such as fungi, bacteria or viruses. Other specific characteristics relate, for example, to the harvested material with regard to quantity, quality, storability, composition and specific constituents. Thus, for example, transgenic plants are known whose starch content is increased, or whose starch quality is altered, or those where the harvested material has a different fatty acid composition.

The use of the compositions according to the invention in economically important transgenic crops of useful plants and ornamentals, for example of graminaceous crops such as wheat, barley, rye, oats, millet, rice and corn, or else crops of sugar beet, cotton, soybean, oilseed rape, potatoes, tomatoes, peas and other vegetables, is preferred. Preferably, the compositions according to the invention can be employed as herbicides in crops of useful plants which resist the phytotoxic effects of the herbicides, or have been made to resist these effects by recombinant techniques.

When using the herbicidal compositions according to the invention in transgenic crops, effects are frequently observed in addition to the effects against harmful plants to be observed in other crops, which are specific for the application in the transgenic crop in question, for example a modified or specifically widened weed spectrum which can be controlled, modified application rates which may be employed for application, preferably good combining ability with the herbicides to which the transgenic crop is resistant, and an effect on growth and yield level of the transgenic crop plants.

The present invention therefore furthermore also relates to a method for controlling undesired vegetation, preferably in crops of plants such as cereals (for example wheat, barley, rye, oats, rice, corn and millet), sugar beet, sugar cane, oilseed rape, cotton and soybean, especially preferred in monocotyledonous plants such as cereals, for example wheat, barley, rye, oats, and their hybrids such as triticale, rice, corn and millet, where one or more herbicidal compositions according to the invention are applied to the harmful plants, plant parts, seeds of the plants or the area on which the plants grow, for example the area under cultivation.

The plant crops may also be genetically modified or have been obtained by mutation selection; they preferably tolerate acetolactate synthase (ALS) inhibitors.

The oil suspension concentrate of the present invention has excellent chemical stability during preparation and storage and is suitable in particular also for combinations of active compounds having different physicochemical properties, for example of a herbicidal thienylsulfonamide which is poorly soluble in organic solvents with a soluble safener and, if appropriate, further soluble agrochemically active compounds. Moreover, the oil suspension concentrate has excellent physical stability, is easy to apply and easy to use and has high biological effectiveness and crop plant compatibility (selectivity).

The oil suspension concentrates described in the examples below were prepared as follows: a premix was prepared in which all soluble components from d), f) and g) and also, if appropriate, the thickener were homogeneously distributed in the solvent or solvent mixture b). Soluble active compounds c) and e) were then dissolved in the premix. Following the dissolution process, solid thienylsulfonamide a) and further insoluble components from c) to g) were suspended in the mixture. The coarse suspension was, after pregrinding, subjected to fine grinding.

The abbreviations used in the examples below have, unless already defined, the following meanings:
Bayol®82=aliphatic mineral oil (boiling range ˜170° C.), Exxon
Bentone® 34=modified phyllosilicate, Elementis
Bentone® 38=modified phyllosilicate, Elementis
Edenor® MESU=rapeseed oil methyl ester, Cognis
Emulsogen® EL-400=polyethoxylated castor oil having 40 ethylene oxide units, Clariant
Genapol® PF10=polyethylene oxide/polypropylene oxide block copolymer having 10% ethylene oxide units, Clariant
Genapol® X060=polyethoxylated isotridecanol having 6 ethylene oxide units, Clariant
Genapol® V4739=polyethoxylated isotridecanol having 6 ethylene oxide units, methoxy-capped, Clariant
Jeffsol® PC=propylene carbonate, Huntsman
Morwet® D425=Na-naphthalene/formaldehyde condensate, Akzo Nobel
Phenylsulfonat® CA100=Ca-dodecylbenzenesulfonate branched, Clariant
Solvesso® 200=aromatic mineral oil (boiling range 219-281° C.), Exxon
Triton® GR-7M E=di(2-ethylhexyl)sulfosuccinate sodium salt in aromatic solvent, DOW

### EXAMPLES

Preparation and storage of an oil suspension concentrate (all amounts in % by weight)

TABLE 1

| | Example | | | | |
|---|---|---|---|---|---|
| | 1 | 2 | 3 | 4 | 5 |
| Compound A2.1 | | 1.02 | 2.00 | 8.85 | 1.02 |
| Compound A2.2 | 1.09 | | | | |
| Compound S1-1 | | | | 26.55 | |
| Compound S1-9 | 2.02 | 2.06 | | | 2.06 |
| Compound S3-1 | | | 4.00 | | |
| Bayol ® 82 | | 55.72 | | | 50.72 |
| Solvesso ® 200 | 51.89 | | 47.00 | 45.2 | |
| Edenor ® MESU | | 8.00 | | | 8.00 |
| Jeffsol ® PC | 1.00 | 0.20 | 1.00 | 0.20 | 0.20 |
| Triton ® GR-7M E | 25.00 | | 25.00 | | 5.00 |
| Genapol ® X060 | | | | | 25.00 |
| Genapol ® V4739 | 10.00 | 25.00 | 10.00 | | |
| Genapol ® PF10 | 2.00 | 7.00 | 2.00 | | 7.00 |
| Emulsogen ® EL-400 | 4.00 | | 4.00 | 8.00 | |
| Phenylsulfonate ® CA100 | | | | 10.00 | |
| Morwet ® D425 | 2.00 | | 2.00 | | |
| Bentone ® 34 | 1.00 | | 1.00 | 1.20 | |
| Bentone ® 38 | | 1.00 | | | 1.00 |
| Na₂CO₃ | | | 2.00 | | |

The formulations of Examples 1 to 5 were stored at 40° C. for 8 weeks, and during this time, they were storage-stable (determined by HPLC).

1. An oil suspension concentrate, comprising
a. one or more herbicidally active compounds from the group of the thienylsulfonamides, and
b. one or more organic solvents.

2. The oil suspension concentrate as claimed in claim 1 which comprises, as component a), one or more herbicidally active compounds from the group of the thienylsulfonylaminocarbonyltriazolinones.

3. The oil suspension concentrate as claimed in claim 1 which comprises, as component b), one or more solvents from the group of unsubstituted or substituted hydrocarbons, polar solvents and fatty acid esters.

4. The oil suspension concentrate as claimed in claim 1 which additionally comprises, as component c), one or more safeners, preferably from the group consisting of dichlorophenylpyrazoline-3-carboxylic acid and its esters, 5,5-diphenyl-2-isoxazoline-3-carboxylic acid and its esters and 8-quinolinoxyacetic acid and its esters.

5. The oil suspension concentrate as claimed in claim 1 which additionally comprises, as component d), one or more sulfosuccinates, preferably from the group of the mono- and diesters of sulfosuccinic acid.

6. The oil suspension concentrate as claimed in claim 1, which additionally comprises e) one or more agrochemically active compounds different from a) and c), f) one or more inorganic salts and/or g) customary auxiliaries and additives.

7. A process for preparing an oil suspension concentrate as claimed in claim 1, which comprises mixing and, if appropriate, grinding the components.

8. A method for controlling harmful plants, which comprises applying an effective amount of an oil suspension concentrate as claimed in claim 1 to the harmful plants, to parts of the plants, to plant seeds or to the area on which the plants grow.

9. The use of an oil suspension concentrate as claimed in claim 1 for controlling harmful plants.

10. The use of an oil suspension concentrate as claimed in claim 1 one or more of claims 1 to 6 for preparing a herbicidal composition.

11. The use as claimed in claim 10 wherein the herbicidal composition is a suspension, an emulsion, a suspoemulsion or a solution.

12. A herbicidal composition, obtainable from an oil suspension concentrate as claimed in claim 1.

13. A method for controlling harmful plants, which comprises applying an effective amount of a herbicidal composition as claimed in claim 12 to the harmful plants, to parts of the plants, to plant seeds or to the area on which the plants grow.

14. The use of a herbicidal composition as claimed in claim 12 for controlling harmful plants.
